(19) United States
(12) Patent Application Publication
(10) Pub. No.: US 2026/0274749 A1
(43) Pub. Date: Sep. 17, 2026

(54) High Tensile Strength Cementitious Matrix For Use In FRCM Systems

(71) Applicant: UNIVERSITÉ LAVAL, Québec (CA)

(72) Inventors: Luca SORELLI, Québec (CA); Ahmed EL REFAI, Waterloo (CA); Yazan ABUTAHNAT, Québec (CA)

(73) Assignee: UNIVERSITÉ LAVAL, Québec, QC (CA)

(21) Appl. No.: 19/480,315

(22) PCT Filed: May 1, 2024
(86) PCT No.: PCT/CA2024/050587

§ 371 Date: Oct. 30, 2025

Related U.S. Application Data
(60) Provisional application No. 63/499,336, filed on May 1, 2023.

(51) Int. Cl. C04B 14/48; C04B 14/04; C04B 14/06; C04B 14/28; C04B 16/06; C04B 18/08; C04B 18/14; C04B 103/32; C04B 111/00; C04B 111/72; E04G 23/02

(52) U.S. Cl. CPC C04B 14/48; C04B 14/048; C04B 14/068; C04B 14/28; C04B 16/0625; C04B 16/0641; C04B 18/08; C04B 18/146; E04G 23/0218; C04B 2103/32; C04B 2111/00482; C04B 2111/72; C04B 2201/52; E04G 2023/0255

(57) ABSTRACT

There is provided herein high tensile strength cementitious matrices for use with a fabric-reinforced cementitious matrix (FRCM) system for repairing a concrete substrate. The FRCM systems include a high tensile strength cementitious matrix according to the present disclosure and a fabric mesh. The high tensile strength cementitious matrices can have an ultimate strength that is at least 1/600^{th} of the ultimate strength of the fabric mesh or at least 2.5 MPa. The high tensile strength cementitious matrices can have a compression strength of at least 70 MPa. The FRCM system can have an ultimate strength that is at least 50% of the ultimate strength of the fabric mesh. The high tensile strength cementitious matrix can exhibit microcracks having a width of less than 100 μm at a service load of the concrete substrate. The high tensile strength cementitious matrix can include 0.3% wt to 8% wt fibers.

### CROSS-REFERENCE TO RELATED APPLICATIONS

This application claims the benefit of U.S. Provisional Patent Application No. 63/499,336 filed May 1, 2023, the entire contents of which are incorporated by reference herein.

### TECHNICAL FIELD

The present disclosure relates to a fabric reinforced cementitious matrix (FRCM) system. Specifically, the present disclosure relates to a high tensile strength cementitious matrix for use in FRCM systems.

### BACKGROUND

Concrete is a commonly used building material for infrastructure projects, such as bridges. However, these concrete structures deteriorate over time, often due to weather-related corrosion. As the concrete deteriorates, the propagation of cracks begins at the surface of the concrete and extends into the structure. Water can penetrate these cracks and accelerate the corrosion. This causes significant maintenance costs for the reparation of the concrete and/or shortens the lifespan of the concrete structure.

Conventional methods of strengthening concrete structures and/or repairing cracks in a concrete structure include repairing the damaged area with a fiber reinforced polymer (FRP) system, which acts as an externally bonded reinforcing system. The FRP system consists of a textile sheet made of continuous high strength fibers that is installed on the concrete surface using an epoxy or polymer adhesive. However, once cured, the FRP system can be brittle, which reduces the overall structural ductility. Furthermore, the epoxy or polymer adhesive can be incompatible with the concrete substrate and is highly affected by high temperatures, which adds vulnerability to fire-related damage.

The damaged concrete element or structure can also be strengthened with a thin layer of Ultra-High-Performance Fibre Reinforced Concrete (UHPFRC) as an overlay, sometimes called UHPC. In some cases, the thin layer of UHPFRC is reinforced with steel bars. However, the UHPFRC layer can be difficult to apply to the underside of horizontal surfaces, such as the underside of a bridge.

Another conventional technique is the Fabric-Reinforced Cementitious Matrix (FRCM) system, which consists of a fabric mesh that covers the area and is bonded to the damaged area at the tension zones with a cementitious matrix. However, once cured, the cementitious matrix can be brittle or weak, causing large cracks to appear due to a low tensile strength. These large cracks can result in the mesh being delaminated from within the matrix (i.e., fabric slippage). Accordingly, the conventional cementitious matrices usually used with conventional FRCM systems are not optimized, resulting in an ineffective use of the fabric mesh that works at only about 20% to about 45% of its ultimate strength (or ultimate stress),

$${σ}_{u}^{Fabric Mesh} ,$$

with localized cracks of large widths being formed.

Accordingly, there is a need for a cost-effective system that would overcome or at least minimize some of the above-discussed concerns.

### SUMMARY

It is therefore an aim of the present invention to address the above-mentioned issues.

According to one aspect, there is provided a fabric-reinforced cementitious matrix (FRCM) system for a concrete substrate, the FRCM system comprising a high tensile strength cementitious matrix and a fabric mesh, wherein an ultimate strength of the high tensile strength cementitious matrix is at least 1/600^{th} of an ultimate strength of the fabric mesh or at least 2.5 MPa.

In some embodiments, the ultimate strength of the high tensile strength cementitious matrix is at least 7 MPa.

In some embodiments, the high tensile strength cementitious matrix has a compression strength of at least 70 MPa.

According to another aspect, there is provided a fabric-reinforced cementitious matrix (FRCM) system for a concrete substrate, the FRCM system comprising a high tensile strength cementitious matrix and a fabric mesh, wherein the high tensile strength cementitious matrix has a compression strength of at least 70 MPa.

In some embodiments, the compression strength of the high tensile strength cementitious matrix is at least 100 MPa.

In some embodiments, the high tensile strength cementitious matrix has an ultimate strength of at least 2.5 MPa.

In some embodiments, an ultimate strength of the FRCM system is at least 50% of an ultimate strength of the fabric mesh.

In some embodiments, the ultimate strength of the FRCM system is at least 75% of the ultimate strength of the fabric mesh.

In some embodiments, the ultimate strength of the FRCM system is at least 90% of the ultimate strength of the fabric mesh.

In some embodiments, the ultimate strength of the FRCM system is equal to or greater than the ultimate strength of the fabric mesh.

In some embodiments, the high tensile strength cementitious matrix comprises: about 100 kg/m³ to about 300 kg/m³ water; about 400 kg/m³ to about 1200 kg/m³ cement; about 600 kg/m³ to about 1500 kg/m³ sand; and at least about 1% wt superplasticizer.

In some embodiments, the high tensile strength cementitious matrix comprises between about 0.3% wt and about 8% wt fibers.

In some embodiments, the high tensile strength cementitious matrix comprises at least 2% wt fibers.

In some embodiments, the fibers comprise at least one of: steel fibers, polyparaphenylene benzobisoxazole (PBO) fibers, carbon fibers, glass fibers, basalt fibers, and synthetic polymer fibers.

In some embodiments, the fibers have a length-to-fiber ratio that is greater than 10.

In some embodiments, the length-to-fiber ratio is greater than 30.

In some embodiments, the length-to-fiber ratio is at least 50.

In some embodiments, the high tensile strength cementitious matrix further comprises polyvinyl alcohol (PVA) fibers as a secondary fiber that is configured to provide fire resistance to the FRCM system.

In some embodiments, the fibers comprise micro-steel fibers.

In some embodiments, a tensile bulk fracture energy of the high tensile strength cementitious matrix is greater than 1/7000^{th} of a tensile bulk fracture energy of the fabric mesh.

In some embodiments, the tensile bulk fracture energy of the high tensile strength cementitious matrix is greater than 1/3500^{th} of the tensile bulk fracture energy of the fabric mesh.

In some embodiments, the tensile bulk fracture energy of the high tensile strength cementitious matrix has a strain

$$( {ε}_{u}^{Cem . Matrix} )$$

at ultimate stress that is greater than 0.1%.

In some embodiments, the fibers comprise ultra-high-molecular-weight polyethylene (UHMW-PE) fibers.

In some embodiments, a tensile bulk fracture energy of the high tensile strength cementitious matrix is greater than 1/1500^{th} of a tensile bulk fracture energy of the fabric mesh.

In some embodiments, the tensile bulk fracture energy of the high tensile strength cementitious matrix has a strain

$$( {ε}_{u}^{Cem . Matrix} )$$

at ultimate stress greater than 0.1%.

In some embodiments, the fibers comprise steel mesh.

In some embodiments, a tensile bulk fracture energy of the high tensile strength cementitious matrix is greater than 1/14000^{th} of a tensile bulk fracture energy of the fabric mesh.

In some embodiments, the tensile bulk fracture energy of the high tensile strength cementitious matrix has a strain

$$( {ε}_{u}^{Cem . Matrix} )$$

at ultimate stress greater than 0.4%.

In some embodiments, the high tensile strength cementitious matrix further comprises about 100 kg/m³ to about 400 kg/m³ supplementary cementitious material (SCM).

In some embodiments, the SCM comprises silica fume, fly ash, slag cement, coal, or a combination thereof.

In some embodiments, the high tensile strength cementitious matrix further comprises about 10 kg/m³ to about 600 kg/m³ mineral filler.

In some embodiments, the mineral filler comprises quartz powder, quartz micro-powder, granite powder, marble powder, limestone powder, or combinations thereof.

In some embodiments, the mineral filler has a diameter of less than 150 μm.

In some embodiments, the FRCM system exhibits microcracks having a width of less than 100 μm at a service load of the concrete substrate.

In some embodiments, the service load of the concrete substrate is about 50% to about 70% of the load-bearing capacity of the concrete substrate.

According to another aspect, there is provided a method of reinforcing a damaged area of a concrete substrate, the method comprising: applying a first layer of a high tensile strength cementitious matrix on the damaged area; embedding a fabric mesh into the first layer of the high tensile strength cementitious matrix; and applying a second layer of the high tensile strength cementitious matrix on the fabric mesh; wherein at least one of: the high tensile strength cementitious matrix has an ultimate strength of at least 2.5 MPa; and the high tensile strength cementitious matrix has a compression strength of at least 70 MPa.

According to another aspect, there is provided a method of reinforcing a damaged area of a concrete substrate, the method comprising: applying a first layer of a high tensile strength cementitious matrix on the damaged area; embedding a fabric mesh into the first layer of the high tensile strength cementitious matrix; and applying a second layer of the high tensile strength cementitious matrix on the fabric mesh; and wherein at least one of: an ultimate strength of the high tensile strength cementitious matrix is at least 1/600^{th} of an ultimate strength of the fabric mesh or at least 2.5 MPa; and an ultimate strength of the FRCM system is at least 50% of the ultimate strength of the fabric mesh.

In some embodiments, the high tensile strength cementitious matrix comprises between about 0.5% wt and about 8% wt fibers.

In some embodiments, the high tensile strength cementitious matrix comprises at least 2% wt fibers.

In some embodiments, the fibers have a tensile strength of between about 1500 MPa and about 6000 MPa.

In some embodiments, the fibers have a diameter of between about 0.001 mm and about 1 mm.

In some embodiments, the fibers have a length of between about 1 mm and about 40 mm.

In some embodiments, the fibers comprise at least one of steel fibers, polyparaphenylene benzobisoxazole (PBO) fibers, carbon fibers, glass fibers, basalt fibers, and synthetic polymer fibers.

In some embodiments, the high tensile strength cementitious matrix further comprises polyvinyl alcohol (PVA) fibers as a secondary fiber that is configured to provide fire resistance to the FRCM system.

In some embodiments, the fibers are the synthetic polymer fibers.

In some embodiments, the synthetic polymer fibers comprise high-density polyethylene (HDPE) and/or ultra-high-molecular-weight polyethylene (UHMWPE).

In some embodiments, the fibers are steel fibers.

In some embodiments, the high tensile strength cementitious matrix comprises: about 100 kg/m³ to about 300 kg/m³ water; about 400 kg/m³ to about 1200 kg/m³ cement; about 600 kg/m³ to about 1500 kg/m³ sand; and at least about 1% wt superplasticizer.

In some embodiments, the high tensile strength cementitious matrix comprises about 100 kg/m³ to about 400 kg/m³ supplementary cementitious material (SCM).

In some embodiments, the SCM comprises silica fume, fly ash, slag cement, coal, or a combination thereof.

In some embodiments, the high tensile strength cementitious matrix comprises about 10 kg/m³ to about 600 kg/m³ mineral filler.

In some embodiments, the mineral filler comprises quartz powder, quartz micro-powder, granite powder, marble powder, limestone powder, or combinations thereof.

In some embodiments, the mineral filler has a diameter of less than 150 μm.

According to another aspect, there is provided a use of a high tensile strength cementitious matrix in a fabric-reinforced cementitious matrix (FRCM) system for repairing a concrete substrate, the FRCM system comprising a fabric mesh and the high tensile strength cementitious matrix, wherein the high tensile strength cementitious matrix comprises between 0.5% wt and 8% wt fibers and wherein the FRCM system exhibits microcracks having a width of less than 100 μm at a service load of the concrete substrate.

In some embodiments, the service load is about 50% to about 70% of the load-bearing capacity of the concrete substrate.

According to another aspect, there is provided a use of a high tensile strength cementitious matrix in a fabric-reinforced cementitious matrix (FRCM) system for a concrete substrate, the FRCM system comprising the high tensile strength cementitious matrix and a fabric mesh, wherein an ultimate strength of the high tensile strength cementitious matrix is at least 1/600^{th} of an ultimate strength of the fabric mesh or at least 2.5 MPa.

In some embodiments, the ultimate strength of the high tensile strength cementitious matrix is at least 7 MPa.

In some embodiments, the high tensile strength cementitious matrix has a compression strength of at least 70 MPa.

According to another aspect, there is provided a use of a high tensile strength cementitious matrix in a fabric-reinforced cementitious matrix (FRCM) system for a concrete substrate, the FRCM system comprising the high tensile strength cementitious matrix and a fabric mesh, wherein the high tensile strength cementitious matrix has a compression strength of at least 70 MPa.

In some embodiments, the compression strength of the high tensile strength cementitious matrix is at least 100 MPa.

In some embodiments, the high tensile strength cementitious matrix has an ultimate strength of at least 2.5 MPa.

According to another aspect, there is provided a use of a high tensile strength cementitious matrix in a fabric-reinforced cementitious matrix (FRCM) system for a concrete substrate, the FRCM system comprising the high tensile strength cementitious matrix and a fabric mesh, wherein an ultimate strength of the FRCM system is at least 50% of an ultimate strength of the fabric mesh.

In some embodiments, the ultimate strength of the FRCM system is at least 75% of the ultimate strength of the fabric mesh.

In some embodiments, the ultimate strength of the FRCM system is at least 90% of the ultimate strength of the fabric mesh.

In some embodiments, the ultimate strength of the FRCM system is equal to or greater than the ultimate strength of the fabric mesh.

In some embodiments, the high tensile strength cementitious matrix comprises: about 100 kg/m³ to about 300 kg/m³ water; about 400 kg/m³ to about 1200 kg/m³ cement; about 600 kg/m³ to about 1500 kg/m³ sand; and at least about 1% wt superplasticizer.

In some embodiments, the high tensile strength cementitious matrix further comprises between about 0.5% wt and about 8% wt fibers.

In some embodiments, the high tensile strength cementitious matrix comprises at least 2% wt fibers.

In some embodiments, the fibers comprise at least one of: steel fibers, polyparaphenylene benzobisoxazole (PBO) fibers, carbon fibers, glass fibers, basalt fibers, and synthetic polymer fibers.

In some embodiments, the high tensile strength cementitious matrix further comprises polyvinyl alcohol (PVA) fibers as a secondary fiber that is configured to provide fire resistance to the FRCM system.

In some embodiments, the fibers comprise micro-steel fibers.

In some embodiments, a tensile bulk fracture energy of the high tensile strength cementitious matrix is greater than 1/3500^{th} of a tensile bulk fracture energy of the fabric mesh.

In some embodiments, the fibers comprise high-density polyethylene (HDPE) fibers.

In some embodiments, a tensile bulk fracture energy of the high tensile strength cementitious matrix is greater than 1/1500^{th} of a tensile bulk fracture energy of the fabric mesh.

In some embodiments, the high tensile strength cementitious matrix further comprises about 100 kg/m³ to about 400 kg/m³ supplementary cementitious material (SCM).

In some embodiments, the SCM comprises silica fume, fly ash, slag cement, coal, or a combination thereof.

In some embodiments, the high tensile strength cementitious matrix further comprises about 10 kg/m³ to about 600 kg/m³ mineral filler.

In some embodiments, the mineral filler comprises quartz powder, quartz micro-powder, granite powder, marble powder, limestone powder, or combinations thereof.

In some embodiments, the mineral filler has a diameter of less than 150 μm.

In some embodiments, the FRCM system exhibits microcracks having a width of less than 100 μm at a service load of the concrete substrate.

In some embodiments, the service load of the concrete substrate is about 50% to about 70% of the load-bearing capacity of the concrete substrate.

### BRIEF DESCRIPTION OF THE DRAWINGS

In order that the invention may be readily understood, embodiments of the invention are illustrated by way of example in the accompanying drawings.

FIG. 1 shows an exploded perspective view of a fabric-reinforced cementitious matrix (FRCM) system being applied to a concrete substrate;

FIG. 2A shows a graphical representation of the stress-strain curve for a conventional FRCM system on a concrete substrate in a tensile test;

FIG. 2B shows a photographic representation of the conventional FRCM system in the tensile test of FIG. 2A at its ultimate stress

$$( {σ}_{u}^{FRCM} )$$

showing fabric slippage;

FIG. 3A shows a graphical representation of the stress-strain curves for various fabric meshes used in FRCM systems during a tensile test;

FIG. 3B shows a graphical representation of the stress-strain curves for FRCM systems using the fabric meshes of FIG. 3A and a conventional cementitious matrix in a tensile test;

FIG. 4 shows a graphical representation of (A) the stress-strain curve for a fabric mesh used in an FRCM system in a tensile test, (B) the stress-strain curve for a conventional (low tensile) cementitious matrix, an ultra-high performance concrete (UHPC), a fiber-reinforced UHPC matrix with less than 2% wt fibers, and a fiber-reinforced UHPC matrix with at least 2% wt fibers in a tensile test, and (C) the stress-strain curve for FRCM systems using the fabric mesh shown in (A) and the cementitious matrices shown in (B) in a tensile test;

FIG. 5A shows a graphical representation of the stress-strain curve for a cementitious matrix according one embodiment in a tensile test with a visualization of the tensile bulk fracture energy of the cementitious matrix (g^{Cem.Matrix});

FIG. 5B shows a graphical representation of the stress-strain curve for a fabric mesh in a tensile test with a visualization of the tensile bulk fracture energy of the fabric mesh (g^{Fabric Mesh});

FIG. 5C shows a graphical representation of the stress-strain curve for a FRCM system according to one embodiment in a tensile test with a visualization of the tensile bulk fracture energy of the FRCM (g^{FRCM});

FIGS. 6A to 6D show graphical representations of load-displacement curves in three (3) tensile tests for (a) a conventional FRCM system with PBO mesh (FIG. 6A); (b) an Eco-FRCM system with PBO mesh using a fiber-reinforced UHPC (UHPFRC) matrix reinforced with 2% 6 mm steel fibers and with part of the cement replaced with a mineral filler (FIG. 6B); (c) an FRCM system with PBO mesh using an UHPFRC matrix reinforced with 2% of 6 mm steel fibers (FIG. 6C); and (d) an FRCM system with PBO mesh using an UHPFRC matrix reinforced with 2% 6 mm UHMW-PE fibers and with part of the cement replaced with a mineral filler (FIG. 6D);

FIG. 6E shows a graphical representation of the average load-displacement curves for the tensile test shown in FIG. 6A for (a) a conventional FRCM system with PBO mesh and the three (3) tensile tests conducted in FIGS. 6B to 6D for (b) the Eco-FRCM system with PBO mesh using a fiber-reinforced UHPC (UHPFRC) matrix reinforced with 2% 6 mm steel fibers and with part of the cement replaced with a mineral filler; (c) the FRCM system with PBO mesh using the UHPFRC matrix reinforced with 2% 6 mm steel fibers; and (d) the FRCM system with PBO mesh using an UHPFRC matrix reinforced with 2% 6 mm UHMW-PE fibers and with part of the cement replaced with a mineral filler;

FIG. 6F shows the photographic representation of FIG. 6E, further including photographic representations of the FRCM systems in the tensile test at their ultimate stress showing the number and size of cracks in each of the respective FRCM systems;

FIG. 7A shows a graphical representation of stress-strain curves in a tensile test for (a) an FRCM system with PBO mesh using a fiber-reinforced UHPC (UHPFRC) matrix reinforced with 2% 6 mm UHMW-PE fibers and with part of the cement replaced with a mineral filler; (b) an Eco-FRCM system with PBO mesh using an UHPFRC matrix reinforced with 2% 6 mm steel fibers and with part of the cement replaced with a mineral filler; (c) an FRCM system with PBO mesh using the UHPFRC matrix reinforced with 2% 6 mm steel fibers; (d) a conventional FRCM system with PBO mesh as reported in (“Guide to Design and Construction of Externally Bonded Fabric-Reinforced Cementitious Matrix and Steel-Reinforced Grout Systems for Repair and Strengthening of Concrete Structures”; ACI 549.4 R-20; ACI: Farmington Hills, MI, USA, 2020 (hereinafter referred to as ACI 549.4)); and (e) a conventional FRCM system with carbon mesh as reported in ACI-549.4.

FIG. 7B to 7D show graphical representations of the gain in the dissipated energy with respect to the conventional FRCM system for (a) an FRCM system using a fiber-reinforced UHPC (UHPFRC) matrix reinforced with 2% 6 mm UHMW-PE fibers and with part of the cement replaced with a mineral filler (FIG. 7B); (b) an FRCM system using an UHPFRC matrix reinforced with 2% 6 mm steel fibers and with part of the cement replaced with a mineral filler (FIG. 7C); and (c) an FRCM system using an UHPFRC matrix reinforced with 2% 6 mm steel fiber (FIG. 7D);

FIGS. 8A to 8D show graphical comparisons between the load-displacement curves of the Example 1 to 3 FRCM systems and the conventional FRCM systems from the literature; namely, (a) Younis, A., Ebead, U., & Shrestha, K. C. (2017), Different FRCM systems for shear-strengthening of reinforced concrete beams, Construction and Building Materials, 153, 514-526 (hereinafter, referred to as Younis et al. (2017)) in FIG. 8A; (b) Pino, V., & Nanni, A. (2015), FRCM and FRP composites for the repair of damaged PC girders (No. RECAST UTC #00042134-04), Research on Concrete Applications for Sustainable Transportation (hereinafter referred to as Pino and Nanni (2015)) in FIG. 8B; (c) Akbari Hadad, H., Nanni, A., Ebead, U. A., & El Refai, A. (2018), Static and fatigue performance of FRCM-strengthened concrete beams, Journal of Composites for Construction, 22(5), 04018033 (hereinafter referred to as Hadad et al. (2018)) in FIG. 8C; and (d) Ye, Y. Y., Smith, S. T., Zeng, J. J., Zhuge, Y., & Quach, W. M. (2021), Novel ultra-high-performance concrete composite plates reinforced with FRP grid: Development and mechanical behaviour, Composite Structures, 269, 114033 (hereinafter referred to as Ye et al. (2021) in FIG. 8D;

FIG. 9A shows a graphical representation of stress-strain curves in a tensile test for FRCM systems using one or two PBO meshes and the cementitious matrices described in Examples 4 to 10 in Tables 3 and 4;

FIG. 9B shows a graphical representation of stress-strain curves in a tensile test for FRCM systems using a single carbon mesh and the cementitious matrices described in Examples 11 to 13 in Tables 3 and 4;

FIG. 10 shows a comparative bubble chart showing the ultimate stress (MPa), the ultimate strain (mm/mm, %), and the tensile bulk fracture energy (energy/unit volume) for the PBO-FRCM systems of the present disclosure using high tensile strength cementitious matrices (Eco and non-Eco FRCM systems) and the conventional FRCM systems published in the literature using conventional cementitious matrices;

FIG. 11A shows a comparative chart showing the maximum crack width against stress for FRCM systems using a PBO mesh and the UHPFRC cementitious matrices of the present disclosure and conventional FRCM systems using a PBO mesh and a non-reinforced cementitious matrices; and

FIG. 11B shows a comparative chart showing the average crack width against stress for FRCM systems using the UHPFRC cementitious matrices of the present disclosure and conventional FRCM systems using non-reinforced cementitious matrices.

### DETAILED DESCRIPTION

As used herein, “substantially”, “approximately”, and/or “about” means an acceptable variation according to conventional standards, otherwise at most a 5% to 10% variation from an indicated effect or value.

There is provided herein a fabric-reinforced cementitious matric (FRCM) system for a concrete substrate that utilizes a high tensile strength cementitious matrix, in combination with a fabric mesh, to repair, reinforce, strengthen, or support the concrete substrate. The FRCM system using the high tensile strength cementitious matrix can be used in a variety of repair or reinforcing applications, including, without limitation, repairing, reinforcing, and/or strengthening a concrete substrate, such as a concrete bridge (including the underside of the bridge), concrete beams, concrete beam-column joints, etc. Concrete substrate can include reinforced and unreinforced concrete surfaces. For example, concrete substrate can include a reinforced concrete beam or beam-column joint (for example, that is reinforced with steel rebars, reinforcing fibers, etc.) before the substrate is repaired, reinforced, and/or strengthening by the FRCM system. In other embodiments, the FRCM system using the high tensile strength cementitious matrix can be used to manufacture new construction materials, such as new beams comprising concrete that are reinforced with an external layer of the FRCM system using the high tensile strength cementitious matrix. In some embodiments, the FRCM system using the high tensile strength cementitious matrix can be used to strengthen or repair the bending strength or shear strength of the concrete substrate.

Referring now to FIG. 1, fabric-reinforced cementitious matrix (FRCM) systems 10 are used to repair a concrete substrate 12 with damage 14. The FRCM system includes external layers on the concrete substrate 12 that include a fabric mesh 16 embedded between two layers 18 of the cementitious matrix. Accordingly, the stress-strain response of both the fabric mesh 16 and the cementitious matrix layers 18 influences the stress-strain response of the overall FRCM system.

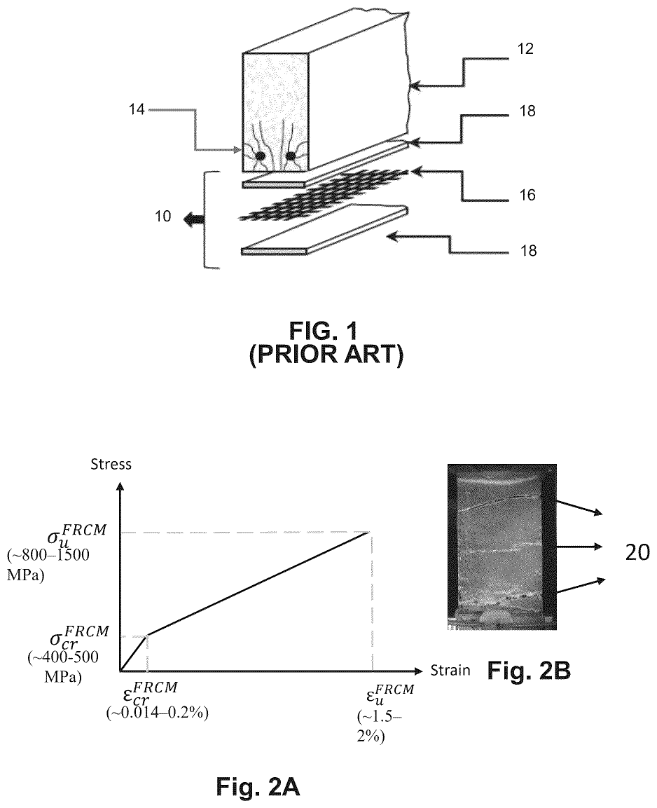

Referring now to FIG. 1 and FIG. 2A, the stress-strain response of an FRCM system 10 (the cementitious matrix 18 and the fabric mesh 16) in tension is generally bilinear. The initial branch of the curve corresponds to the uncracked system followed by a second branch with a reduced slope. The tensile curve of the FRCM system is generally defined by three points; namely, (0.0), the cracking point

$$( {σ}_{cr}^{FRCM} , {ε}_{c r}^{FRCM} ) ,$$

and the ultimate point

$$( {σ}_{u}^{FRCM} , {ε}_{u}^{FRCM} ) ,$$

which can also be referred to as ultimate stress. In contrast, the stress-strain response of the fabric mesh 16 is linear to its ultimate stress

$$( {σ}_{u}^{F abric Mesh} ) .$$

The conventional FRCM system 10 that use conventional cementitious matrix layers 18 has been shown to exhibit initial linear behaviour that is negligible. In other words, the load carrying capacity of conventional matrices do not contribute to the overall load carrying capacity of the FRCM system 10. Moreover, FRCM systems 10 that use conventional cementitious matrix layers 18 have been shown to have an ultimate stress, also referred to as the ultimate strength

$$( {σ}_{u}^{C e m . Matrix} ) ,$$

that is significantly less than the ultimate stress of the fabric mesh 16

$$( {σ}_{u}^{F abric Mesh} ) .$$

In some cases, the ultimate stress

$$( {σ}_{u}^{FRCM} )$$

of the conventional FRCM systems 10 that use conventional cementitious matrix 18 is between 20% and 45% of the ultimate stress of the fabric mesh. Accordingly, when a conventional FRCM system 10 that uses conventional cementitious matrix 18 is used, 2 to 5 times the number of the fabric meshes 16 can be required to have a load carrying capacity of a single fabric mesh 16 by itself due to the low tensile strength and low tensile bulk fracture energy in the cementitious matrix layer 18.

With specific reference to FIG. 2A, a graphical representation of a conventional FRCM system under load is shown by plotting the tensile stress against the strain of the FRCM system. This test can be conducted according to ACI 549 guidelines to ensure there is no slip between the FRCM system and the metal grips. For example, when conducting the test, the internal faces of the metal grips can be sandblasted to enhance the grip traction. As can be seen in FIG. 2A, the stress-strain curve is characterized by an initial linear behaviour until the conventional cementitious matrix layer cracks. FIG. 2B shows a photograph of the conventional FRCM system at its ultimate stress of the system

$$( {σ}_{u}^{FRCM} ) ,$$

which shows the development of three wide localized cracks that resulted in fabric slippage 20 causing failure.

Indeed, FIGS. 2A and 2B show that the first crack of the conventional FRCM system occurs at a stress

$$( {σ}_{c r}^{FRCM} )$$

of approximately 400 to 500 megapascals (MPa) and at a strain

$$( {ε}_{c r}^{FRCM} )$$

of approximately 0.014% to 0.2%. Due to the large size of the developed cracks, the conventional FRCM system leads to fabric slippage at a stress

$$( {σ}_{u}^{FRCM} )$$

of approximately 800 to 1500 MPa depending on the fabric mesh type, which is significantly less than the tensile strength of the fabric mesh alone.

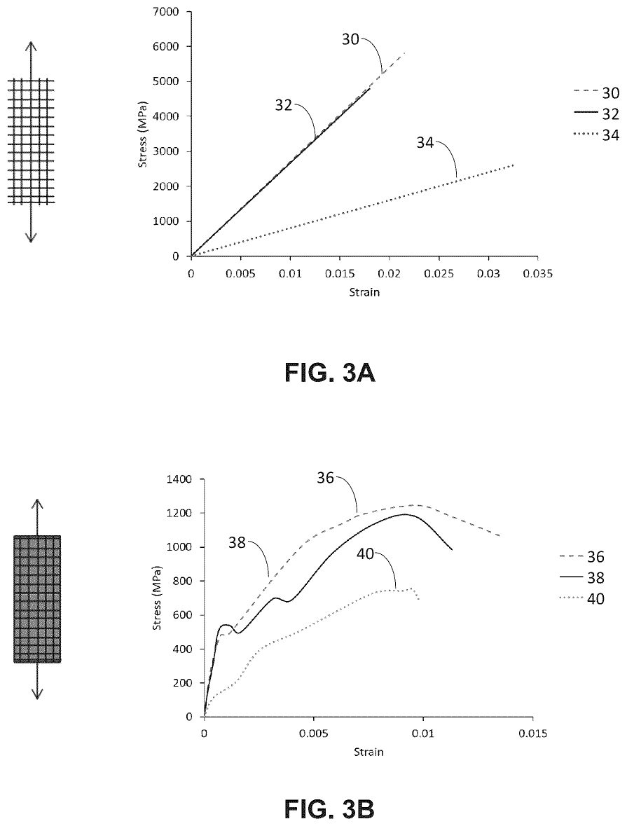

Referring now to FIGS. 3A and 3B, a graphical representation of a stress-strain curve for a PBO fabric mesh 30, a carbon fabric mesh 32, and a glass fabric mesh 34 (FIG. 3A) is shown in comparison to a stress-strain curve for conventional FRCM systems using those meshes bonded with a conventional cementitious matrix (FIG. 3B). Specifically, FIG. 3B shows the stress-strain curve for a conventional PBO mesh FRCM system 36, a conventional carbon fabric mesh FRCM system 38, and a conventional glass fabric mesh FRCM system 40.

The mean tensile properties of the respective mesh 30, 32, 34 and FRCM systems 36, 38, 40 are shown in Table 1. Values lower or higher than those shown in the table can be found depending on the specific mesh type and the fabrication process. For example, a PBO mesh having an ultimate stress σᵤ(MPa) of between 2500 to 7000 MPa, a carbon mesh having an ultimate stress σᵤ(MPa) of between 2000 to 6000 MPa, or a glass mesh having an ultimate stress σᵤ(MPa) of between 1800 to 4000 MPa can be used.

TABLE 1

| | PBO | PBO- | Carbon | Carbon- | Glass | Glass- |
|---|---|---|---|---|---|---|
| | Mesh | FRCM | Mesh | FRCM | Mesh | FRCM |
| Ultimate | 3300- | 1235- | 3000- | 1178- | 2600 | 767 |
| Stress | 5800 | 1500 | 4800 | 1300 | | |
| σᵤ (MPa) | | | | | | |
| Ultimate | 2.15 | 1.06 | 1.8 | 1.04 | 3.25 | 0.93 |
| Strain εᵤ (%) | | | | | | |
| Ultimate | 0.5- | — | 0.5- | — | 0.5- | — |
| Deformation | 5 | | 5 | | 7 | |
| (%) | | | | | | |
| Mesh | 21.3-45.5 | | 24.5-43.3 | | 29.5 | |
| Utilization | | | | | | |
| (%) | | | | | | |

As can be seen, depending on the type of mesh being used, when bonded to the damaged area with a conventional cementitious matrix, only between approximately 21.3% and 45.5% of the ultimate strength of the mesh is being utilized.

It has been found that by increasing the cracking stress and the ultimate stress of a strain hardening cementitious matrix

$$( {σ}_{c r}^{C em . Matrix} , {σ}_{u}^{C e m . Matrix} ) ,$$

respectively, up to 100% of the ultimate strength of the fabric mesh

$$( {σ}_{u}^{FRCM} )$$

can be utilized. It is understood that a strain hardening cementitious matrix is characterised by an ultimate strength

$$( {σ}_{u}^{Cem . Matrix} )$$

that is higher than the cracking stress

$$( {σ}_{c r}^{Cem . Matrix} ) .$$

By increasing the cracking stress of the cementitious matrix

$$( {σ}_{c r}^{C em . Matrix} ) ,$$

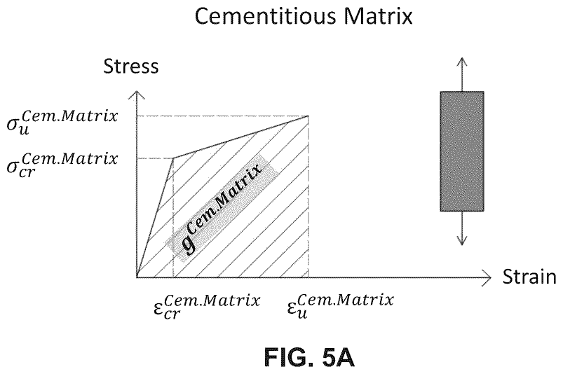

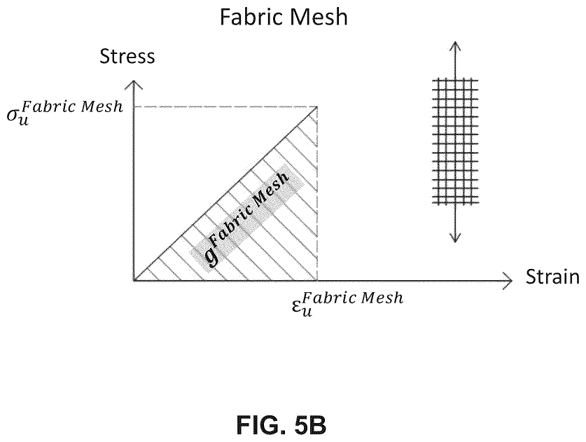

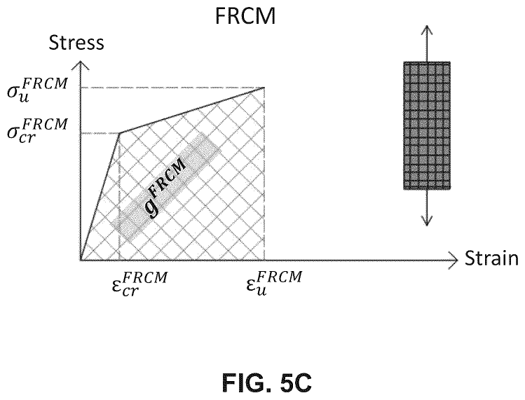

the first crack in the FRCM system begins to form at a higher load than that of the conventional FRCM systems. Furthermore, it has been found that FRCM systems using a high tensile bulk fracture energy cementitious matrix (g^{Cem.Matrix}) according to the present disclosure exhibit cracks that are generally less than 100 μm, which corresponds to a reduction in crack size at the service load by a factor of 10 when compared to those of the conventional cementitious matrices. Reducing the size of the cracks that occur at the service load can enhance the durability and structural lifetime of the concrete structure. The tensile bulk fracture energy is the amount of energy absorbed to create a unit area of a crack and is thus used to describe the fracture property and crack resistance capacity of the cementitious matrix. It is calculated as the area under the stress-strain curve (FIG. 5).

By using a cementitious matrix with a higher ultimate strength

$$( {σ}_{u}^{C em . Matrix} )$$

and high tensile bulk fracture energy (g^{Cem.Matrix}) the maximum load bearing capacity of the fabric can be utilized without delamination or slippage of the fabric at the FRCM system's ultimate stress, which in turn can increase the load bearing capacity of the FRCM system. In some embodiments, for example when the ultimate strength of the FRCM system

$$( {σ}_{u}^{F R C M} )$$

matches the ultimate strength of the fabric mesh

$$( {σ}_{u}^{F abric Mesh} ) ,$$

the load bearing capacity of the FRCM system can be increased by a factor of about 2 to about 5 over conventional FRCM systems.

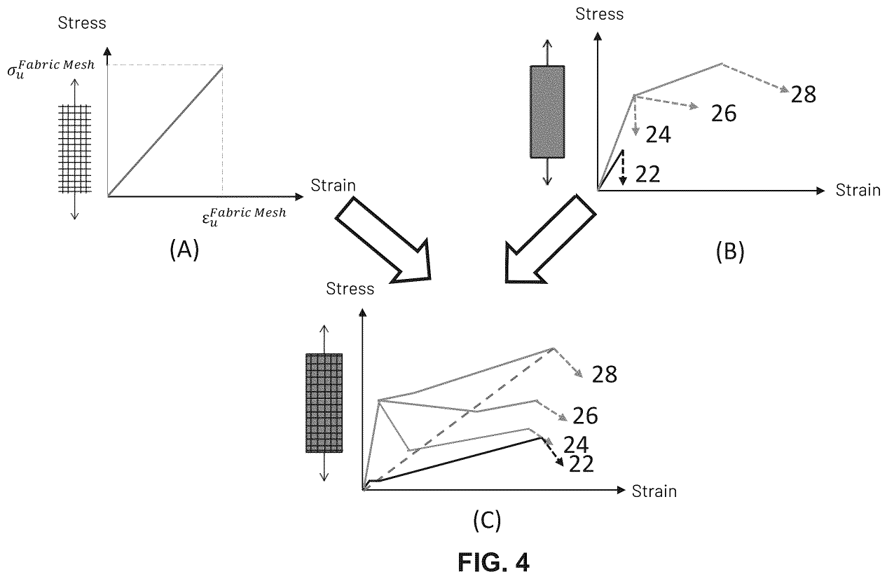

Referring now to FIG. 4, a graphical representation of a stress-strain curve for an exemplary fabric mesh (A), four types of cementitious matrix layers (B), and the exemplary tensile stress-strain curves of four FRCM systems corresponding to the four types of the cementitious matrices (C) is shown. The four types of cementitious matrices shown in FIG. 4 (B) include a conventional (low tensile) cementitious matrix (CM) 22 that is compared to three UHPC matrices according to the present disclosure. Specifically, a UHPC matrix without fibers 24, a UHPC matrix with less than 2% wt fibers 26, and a UHPC matrix with at least 2% wt of fibers 28 were compared against the conventional CM 22. Similarly, the stress-strain curves of those specific four FRCM systems are shown in FIG. 4 (C).

As can be seen, the stress-strain curve of the mesh (shown in (A)) is linear to its ultimate stress

$$( {σ}_{u}^{F abric Mesh} ) ,$$

whereas the stress-strain curves of the four types of cementitious matrices (shown in (B)) alone are bilinear. Specifically, FIG. 4 (B) shows the cracking stress, also referred to as the cracking strength

$$( {σ}_{c r}^{C em . Matrix} ) ,$$

of each of the four cementitious matrices, whereas (C) shows the bilinear graph defined by (0,0), the cracking stress, and the ultimate stress of the FRCM systems

$$( {σ}_{cr}^{F R C M} , {σ}_{u}^{F R C M} ) ,$$

respectively, corresponding to the four cementitious matrices.

The bilinear behaviour of the conventional FRCM with the CM 22 includes a first linear slope (up to the cracking stress,

$${σ}_{c r}^{F R C M} )$$

that is negligible, which is expected for conventional FRCM systems. Indeed, in the design standards for conventional externally bonded FRCM systems, the first linear slope is not considered (ACI 549.4). The conventional FRCM with a conventional CM 22 has an ultimate stress

$$( {σ}_{u}^{F R C M} )$$

that is significantly less than the ultimate stress of the mesh by itself

$$( {σ}_{u}^{F abric Mesh} ) ,$$

resulting in less than 50% of the ultimate strength of the mesh being utilized.

By using a high tensile strength cementitious matrix, it has been found that the FRCM systems are characterized by a bilinear stress-strain curve in which the initial or first linear slope is not negligible, which can result in low cracking during the service state and high impermeability of environmental factors, such as water. Furthermore, in FRCM systems using high tensile strength cementitious matrices, the fabric mesh breaks or ruptures at its ultimate stress due to the bridging effects of the short fibers in the high tensile FRCM with the cementitious matrix. This maximizes the energy dissipation as slippage is followed by fabric rupture, thus allowing the full strength of the mesh to be utilized.

By increasing the ultimate strength of the cementitious matrix

$$( {σ}_{u}^{C em . Matrix} )$$

used in the FRCM system, it has been found that the FRCM system can exhibit a higher first crack strength and higher load-bearing capacity than the conventional system. As shown in FIGS. 4 (B) and (C), the UHPC matrices 24, 26, and 28 have a higher cracking stress

$$( {σ}_{u}^{C em . Matrix} ) ,$$

resulting in the cementitious matrix developing cracks under a higher load than the conventional CM 22. Moreover, the improvements to the FRCM system when a high tensile strength cementitious matrix is used have been observed at both the service limit state (SLS) and the ultimate limit state (ULS).

Referring now to FIGS. 5A, 5B, and 5C, graphical representations of the stress-strain curves and the tensile bulk fracture energy for a high tensile strength cementitious matrix (FIG. 5A), for an exemplary fabric mesh (FIG. 5B), and for an exemplary FRCM system (FIG. 5C) are shown. Specifically, FIG. 5A shows the cracking stress

$$( {σ}_{c r}^{Cem . Matrix} ) ,$$

the ultimate stress

$$( {σ}_{u}^{C e m . Matrix} ) ,$$

the cracking strain

$$( {ε}_{c r}^{C e m . Matrix} ) ,$$

the ultimate strain

$$( {ε}_{u}^{Cem . Matrix} ) ,$$

and the tensile bulk fracture energy (g^{Cem.Matrix}) for the high tensile strength cementitious matrix. FIG. 5B shows the ultimate stress

$$( {σ}_{u}^{F abric Mesh} ) ,$$

the ultimate strain

$$( {ε}_{u}^{F abric Mesh} ) ,$$

and the tensile bulk fracture energy (g^{Fabric Mesh}) for the fabric mesh. FIG. 5C shows the cracking stress

$$( {σ}_{c r}^{FRCM} ) ,$$

the ultimate stress

$$( {σ}_{u}^{FRCM} ) ,$$

the cracking strain

$$( {ε}_{c r}^{FRCM} ) ,$$

the ultimate strain

$$( {ε}_{u}^{FRCM} ) ,$$

and the tensile bulk fracture energy (g^{FRCM}) for the FRCM system. The tensile bulk fracture energy is defined as the area underneath the stress-strain tensile curve of FIG. 5A, FIG. 5B, and FIG. 5C for matrix, mesh and FRCM, respectively. The tensile bulk fracture energy of the matrix can be calculated with a direct tensile test (e.g., according to AASHTO T397 or equivalent direct tensile tests) or by inverse analysis from bending tests as indicated in CSA A23.1 Annexe U, CSA S6 Annexe 8 or SIA 2052 or equivalent inverse analysis of bending test. The tensile bulk fracture energy of the mesh and FRCM can be estimated from the direct tensile tests.

In some embodiments, the tensile bulk fracture energy of the high tensile strength cementitious matric has an ultimate strain

$$( {ε}_{u}^{C e m . Matrix} )$$

that is greater than 0.1% or greater than 0.2%.

High tensile strength cementitious matrices have surprisingly shown to allow for maximum energy dissipation at the maximum load bearing capacity of the fabric mesh without delamination of the fabric mesh, as well as reducing the crack size of the cementitious matrix layer due to the higher stiffness of the system. In some embodiments, use of the high tensile strength cementitious matrices can increase the delamination strength of the overall FRCM system as the optimized bond between the high tensile strength cementitious matrix and the fabric mesh will delay the delamination of the layers of FRCM system.

To achieve maximum energy dissipation and utilize the maximum loading capacity of the fabric mesh, the high tensile strength cementitious matrix can be an ultra-high strength matrix configured to optimize the ultimate strength of the fabric mesh. For example, the high tensile strength cementitious matrix can include HPC or UHPC, which generally has a compression strength of at least 70 MPa and a tensile strength of at least 2.5 MPa. In some embodiments, the high tensile strength cementitious matrix can have a tensile strength of at least 5 MPa. In some embodiments, the high tensile strength cementitious matrix includes a modified UHPC with a reduced volume of cement that is replaced with a mineral filler. Replacing a portion of the cement with a mineral filler can reduce the cost of the cementitious matrix and/or lower the carbon footprint of the FRCM system (eco-FRCM system).

In some embodiments, the high tensile strength cementitious matrix can be a cementitious matrix that has an ultimate stress of at least 70 MPa in compression (i.e., compression strength of at least 70 MPa) and a tensile ultimate strength of at least 2.5 MPa or at least 5 MPa. In some embodiments, the cementitious matrix has a tensile ultimate strength of at least 7 Mpa and/or a compression strength of at least 100 Mpa. A cementitious matrix having an ultimate stress of at least 70 Mpa in compression can be referred to as a high tensile strength cementitious matrix.

To utilize the maximum loading capacity of the fabric mesh, the high tensile strength cementitious matrix can be configured to have an ultimate strength,

$${σ}_{u}^{C e m . Matrix} ,$$

that is determined by the following formula:

$${σ}_{u}^{Cem . Matrix} > max ( 2.5 Mpa , \frac{{σ}_{u}^{F abric Mesh}}{600} )$$

$$or$$

$${σ}_{u}^{Cem . Matrix} > max ( 5 MPa , \frac{{σ}_{u}^{F abric Mesh}}{600} )$$

By increasing the ultimate strength of the cementitious matrix

$$( {σ}_{u}^{C e m . Matrix} )$$

layers at least 1/600^{th} of the ultimate strength of the fabric mesh, the tensile strength of the FRCM system can be optimized or maximized.

In some embodiments, the optimized ultimate strength of the high tensile strength cementitious matrix in use with the fabric mesh, can result in at least 50% of the ultimate strength of the mesh

$$( {σ}_{u}^{F abric Mesh} )$$

being utilized in the FRCM system. In some embodiments, at least 60%, at least 75%, or at least 90% of the ultimate strength of the fabric mesh can be utilized in the FRCM system. In other words, the ultimate strength of the FRCM system is at least 50%, at least 60%, at least 75%, at least 90%, or 100% of the ultimate strength of the fabric mesh.

Indeed, it has surprisingly been found that the use of a high tensile strength cementitious matrix with high strength, high ductility, and large fracture energy can increase the cracking strength (MPa)

$$( {σ}_{c r}^{FRCM} ) ,$$

the ultimate strength (MPa)

$$( {σ}_{u}^{F R C M} ) ,$$

and in some embodiments the ultimate strain (mm/mm)

$${ε}_{u}^{FRCM}$$

of the FRCM system, such that the ultimate strength of the FRCM system matches or exceeds the ultimate strength of either the textile mesh or the cementitious matrix by themselves.

### FRCM Systems

Referring back to FIG. 1, FRCM systems 10 are applied to a concrete substrate 12 with damage 14. The exemplary FRCM system 10 includes a single external layer that includes a first cementitious matrix layer 18 applied to the damage 14 on the concrete substrate 12, a fabric mesh 16 applied to the first cementitious matrix layer 18, and a second cementitious matrix layer 18 applied to the fabric mesh 16. In some embodiments, each of the first and second cementitious layers 18 can be between about 4 mm and about 40 mm thick. In some embodiments, the FRCM system 10 can include two or more external layers in a stacking configuration. The stacking configuration can include fabric meshes 16 whose filaments are aligned with each other, aligned in opposing orientations (i.e., filaments of the stacked fabric meshes 16 being orientated perpendicular to each other), or stacked fabric meshes overlapping to cover a large area.

In some embodiments, the cementitious matrix layers 18 of the FRCM system 10 includes a high tensile strength cementitious matrix. When in use, the FRCM system includes at least one fabric mesh panel 16 externally bonded to a concrete substrate between two layers of the high tensile strength cementitious matrix. In some embodiments, the fabric mesh 16 can include a polyparaphenylene benzobisoxazole (PBO) mesh, a carbon mesh, a glass mesh, an aramid mesh, a basalt mesh, a steel mesh, a polymer mesh, or a combination thereof.

The high tensile strength cementitious matrix can include about 100 kg/m³ to about 300 kg/m³ water, about 400 kg/m³ to about 1200 kg/m³ cement, about 600 kg/m³ to about 1500 kg/m³ sand, such as fine sand, natural sand, silica sand, or a combination thereof, and at least about 1% wt superplasticizer.

In some embodiments, the high tensile strength cementitious matrix can be ultra-high-performance concrete (UHPC) or ultra-high-performance fiber-reinforced concrete (UHPFRC). For example, the high tensile strength cementitious matrix can be fiber-reinforced with about 0.3% wt to about 8% wt high tensile strength fibers. It is theorized that the addition of short fibers in the cementitious matrix, in addition to increasing the tensile strength of the matrix, results in the fibers working simultaneously with the fabric mesh to increase the ultimate tensile strength of the FRCM system and reduce the width of the crack size to produce multiple microcracks. The formation of multiple microcracks, as opposed to 2 or 3 wide cracks, results in the FRCM surface remaining impermeable during the strain hardening stage of the high tensile strength cementitious matrix (i.e., during the second linear stage between the cracking stress and the ultimate stress of the high tensile strength cementitious matrix).

In some embodiments, the high tensile strength fibers can include steel fibers, polyparaphenylene benzobisoxazole (PBO) fibers, carbon fibers, glass fibers, basalt fibers, or synthetic polymer fibers, such as high-density polyethylene (HDPE) fibers or ultra-high-molecular-weight polyethylene (UHMW-PE) fibers, or a combination thereof. The high tensile strength fibers can have a diameter of about 0.001 mm to about 1 mm and a length of about 1 mm to about 40 mm. The fibers can be microfibers, which generally have a diameter of less than 0.6 mm, and preferably have a diameter of less than 0.2 mm, or can be macrofibers, which generally have a diameter of greater than or equal to 0.6 mm.

In some embodiments, the high tensile strength fibers are selected from fibers that have a high tensile strength, such as between about 1000 MPa and about 6000 MPa. It is understood that the fibers can have different lengths, diameters, and/or shapes. In some embodiments, the fibers have a fiber ratio (i.e., a length-to-diameter ratio) that is greater than 10, greater than 30, or greater than 50.

In some embodiments, a mixture of type and/or size of fibers can be used to obtain desired properties. For example, the high tensile strength fibers can include a combination of microfibers and macrofibers. For example, the fibers can include a mixture of microfibers that are 0.2 mm in diameter and 12 mm in length and macrofibers that are 0.6 mm in diameter and between 40 and 50 mm in length.

In some embodiments, polyvinyl alcohol (PVA) can be added as a secondary fiber, or in combination with the aforementioned fibers, to confer fire resistance property to the FRCM system by releasing the water pressure when the vapor pressure increases in the capillary pores of the high-tensile strength matrix due to high temperature.

In some embodiments, steel fibers or micro-fibers can be used in the high tensile strength cementitious matrix. The steel micro-fibers can have a diameter of about 0.05 mm to about 0.6 mm and a length of about 4 mm to about 30 mm. The tensile strength of the steel micro-fibers can be between about 1800 MPa to about 5000 MPa.

In some embodiments, UHMW-PE or HDPE fibers can be used in the high tensile strength cementitious matrix. The UHMW-PE or HDPE fibers can have a diameter of between about 0.002 to about 0.05 mm and a length of between about 2 mm and about 30 mm. In some embodiments, the UHMW-PE fibers have a Young's E-modulus of between about 20 and about 300 gigapascals (GPa) and a tensile strength of about 1000 to 4000 MPa.

In some embodiments, the high tensile strength cementitious matrix can be optimized based on its tensile bulk fracture energy. For example, a high tensile strength cementitious matrix reinforced with at least 2% steel fibers should have a tensile bulk fracture energy (g^{Cem.Matrix}) that is greater than about 1/7000^{th} of the tensile bulk fracture energy of the fabric mesh (g^{Fabric Mesh}). Accordingly, the steel fiber-reinforced cementitious matrix can be optimized to have a tensile bulk fracture energy according to the following formula:

$${g}^{Cem . Matrix} > \frac{{g}^{F a bric Mesh}}{7000}$$

As another example, a high tensile strength cementitious matrix reinforced with at least 2% UHMW-PE fibers should have a tensile bulk fracture energy (g^{Cem.Matrix}) that is greater than 1/1500^{th} of the tensile bulk fracture energy of the fabric mesh(g^{Fabric Mesh}). Accordingly, the UHMW-PE fiber-reinforced cementitious matrix can be optimized to have a tensile bulk fracture energy according to the following formula:

$${g}^{Cem . Matrix} > \frac{{g}^{F a bric Mesh}}{1500}$$

In some embodiments, the high tensile strength cementitious matrix can include one or more supplementary cementitious material (SCM), such as, without limitation, silica fume, fly ash, slag cement, or coal. The cementitious matrix can include between about 100 kg/m³ to about 400 kg/m³ SCM, or about 200 kg/m³ to about 300 kg/m³ SCM.

In some embodiments, the cementitious matrix can include a mineral filler to reduce the total amount of cement being used. The mineral filler can include, without limitation, materials such as quartz powder, quartz micro-powder, granite powder, marble powder, limestone powder, or combinations thereof. In some embodiments, the mineral powder has a diameter of less than 150 μm. In some embodiments, between about 10 kg/m³ and about 600 kg/m³ of mineral filler can be used in the high tensile strength cementitious matrix, or between about 200 kg/m³ and about 500 kg/m³ mineral filler.

### EXAMPLES

### Examples 1 to 3

Sample UHPFRC matrices were tested with a PBO mesh having a tensile strength of between about 3300 and 5800 MPa and an ultimate strain between 1.45% and 2.15%. Three exemplary UHPFRC matrices were used to bond the PBO mesh to a concrete substrate, the compositions of which are in Table 2. In the exemplary system, the first layer of exemplary UHPFRC (i.e., the layer applied to the concrete substrate) was 5 mm thick and the second layer of exemplary UHPFRC (i.e., the layer applied to the PBO mesh) was 5 mm thick. Each layer had a size of about 400 mm×60 mm (40 cm×6 cm). The example FRCM systems were each tested three times and the average compression strengths, shown in Table 2, were recorded.

TABLE 2

| | Example 1 | Example 2 | Example 3 |
|---|---|---|---|
| | (UHPFRC- | (eco-UHPFRC- | (eco-UHPFRC- |
| | steel) | steel) | UHMW-PE) |
| Cement (kg/m³) | 900 | 400 | 400 |
| Mineral Filler | (8.54%) | (19.95%) | (19.78%) |
| (% of total) | | | |
| quartz micro-powder | 211 | — | — |
| (kg/m³) | | | |
| granite powder | — | 200 | 200 |
| (kg/m³) | | | |
| Limestone (kg/m³) | — | 260 | 260 |

SCM (kg/m³)

| | | | |
|---|---|---|---|
| Silica Fume | 231 | 80 | 80 |
| Fly Ash | — | 200 | 200 |
| Sand (kg/m³) | | | |
| Fine sand | 1020 | | |
| Natural sand | | 590 | 590 |
| Silica Sand | | 400 | 400 |
| Water (kg/m³) | 109 | 176 | 195 |
| Total Cement, Filler, SCM, | 2471 | 2306 | 2325 |
| Sand, + Water (kg/m³) | | | |
| Superplasticizer | 3.3 | 7.2 | 8 |
| (wt % of cement) | | | |
| Fibers | | | |
| Steel (wt %) with length | 2 | 2 | — |
| of about 6 mm | | | |
| UHMW-PE (wt %) with length | — | — | 2 |
| of about 6 mm | | | |
| Compression strength (MPa) | 156 | 110 | 102 |

As can be seen, the UHPFRC matrices each included a mineral filler. Example 1 included about 8.54% mineral filler comprising quartz micro-powder based on the total weight of the cement, mineral filler, supplementary cementitious materials (SCM), sand, and water. In contrast, Examples 2 and 3 included 19.95% and 19.78%, respectively, mineral filler based on the total weight. The mineral filler in Examples 2 and 3 comprised 200 kg/m³ granite powder and 260 kg/m³ limestone. Examples 2 and 3 also included a higher overall amount in kg/m³ of SCM than Example 1, allowing the total amount of cement to be reduced from 900 kg/m³ in Example 1 to 400 kg/m³ in Examples 2 and 3.

The UHPFRC example matrices each include 2% wt fibers. The fibers in Examples 1 and 2 were steel fibers having a length of 6 mm and a diameter of 0.2 mm. The steel fibers had a Young's Modulus of 205 GPa and a tensile strength of 2860 MPa. The fibers in Example 3 were ultra high molecular weight (UHMW) polyethylene (PE) fibers (UHMW-PE) having a length of 6 mm and a diameter of 0.012 mm. The UHMW-PE fibers had a Young's Modulus of 103 GPa and a tensile strength of 3100 MPa.

### Experiments—Examples 1 to 3

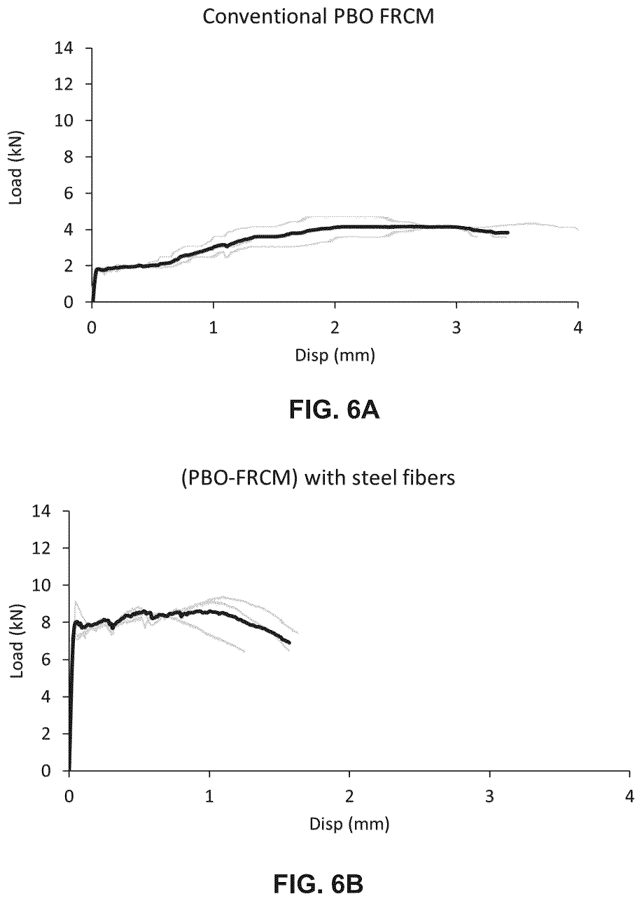

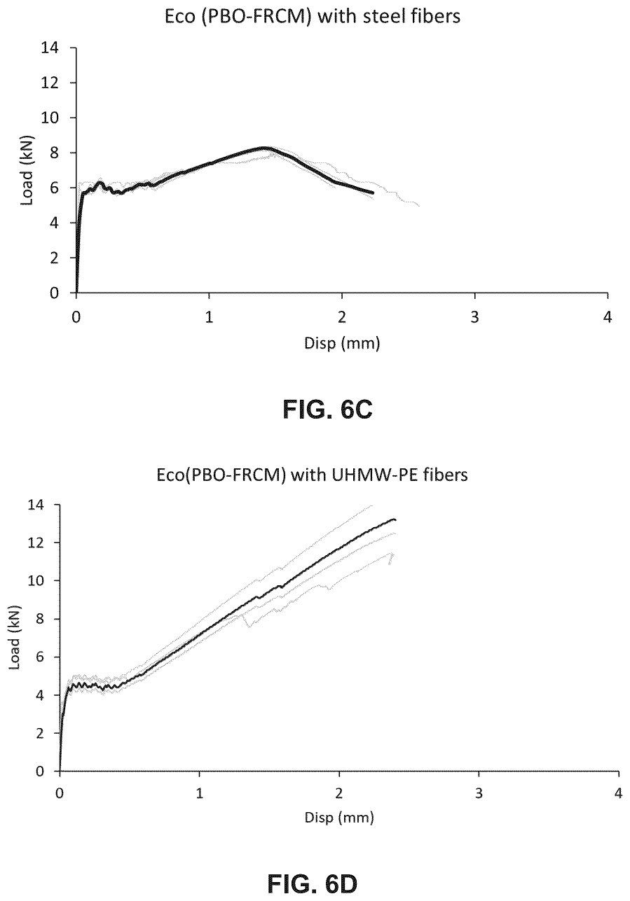

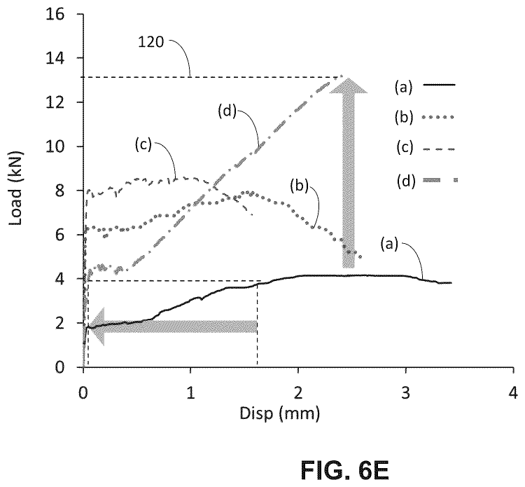

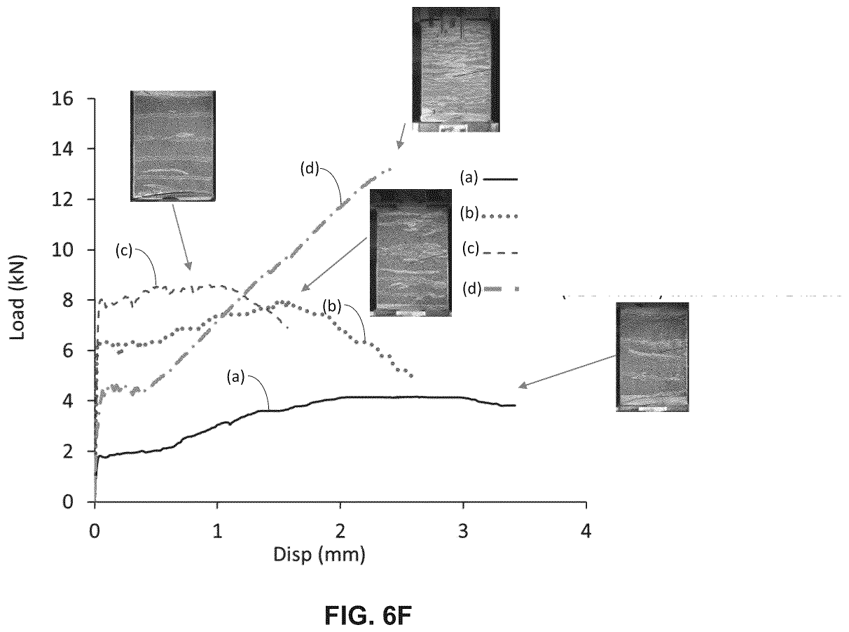

Referring now to FIGS. 6A to 6F, the load-displacement properties for FRCM systems using the UHPFRC matrices in Table 2 were compared with the load-displacement properties of a conventional FRCM system using a conventional, commercially available cementitious matrix. As can be seen, load-displacement curves for (a) a conventional FRCM system (shown in FIGS. 6A, 6E, and 6F), (b) an FRCM system using about 6 mm steel fiber-reinforced UHPFRC with part of the cement replaced with a mineral filler (hereinafter eco-UHPFRC, Example 2) (shown in FIGS. 6B, 6E, and 6F), (c) an FRCM system using about 6 mm steel fiber-reinforced UHPFRC (Example 1) (shown in FIGS. 6C, 6E, and 6F), and (d) an FRCM system using UHMW-PE fiber-reinforced eco-UHPFRC (Example 3) (shown in FIGS. 6D, 6E, and 6F) are shown.

The conventional FRCM (a) showed bilinear behaviour up to its ultimate load, for which the first linear part is negligible, and an ultimate load of about 4 kN. In contrast, each of the high tensile strength cementitious matrices (Examples 1 to 3) exhibited a significantly higher first peak load as well as a higher ultimate load (an increase of up to factor of about 3). Moreover, the displacement at the service load (at about 3 kN) of the conventional FRCM (a) was about 1 mm versus less than 0.1 mm in the UHPFRC-FRCM systems (Examples 1 to 3), which means that the crack width in the cementitious matrix layer is reduced by a factor of about 10 when using a high tensile strength cementitious matrix. This reduction in the crack width during service loading can provide impermeability to the existing structure and strongly contributes to the durability of the strengthened or reinforced concrete substrate (i.e., the concrete structure being repaired).

When comparing Examples 1 to 3 against each other, as can be seen, all the FRCM systems using a high tensile strength cementitious matrix exhibited a displacement at the service load (about 3 kN) of less than 0.1 mm. The service load of the concrete substrate can also be expressed in stress (MPa). In some embodiments, the service stress is about 50% to about 60% of the maximum stress (which can also be referred to as strength). In some embodiments, the service load (in terms of flexion) of the concrete substrate is about 50 to about 70% of the load-bearing capacity of the concrete substrate.

The FRCM system using an eco-UHPFRC matrix reinforced with about 6 mm steel fibers (Example 2, FIG. 6B and (b) in FIGS. 6E and 6F) exhibited a lower first peak load and a lower ultimate load than the FRCM system using an UHPFRC matrix reinforced with about 6 mm steel fibers (Example 1, FIG. 6C and (c) in FIGS. 6E and 6F). Surprisingly, the FRCM system using an eco-UHPFRC matrix reinforced with UHMW-PE fibers (Example 3, FIG. 6D and (d) in FIGS. 6E and 6F) exhibited the lowest first peak load (i.e., the lowest load at the first sign of a crack) of the FRCM systems using UHPFRC matrices, yet the highest ultimate load (about 13 kN, which is over 3 times the ultimate load of the conventional FRCM system (a)). It is theorized that the higher tensile strength of the UHMW-PE fibers increase the tensile bulk fracture energy of the FRCM system. It is further theorized that the UHMW-PE fibers increase the tensile bulk facture energy by increasing the ductility of the FRCM system. The tensile bulk fracture energy is the amount of energy absorbed to create a unit area of a crack and is thus used to describe the fracture property and crack resistance capacity of the cementitious matrix.

With specific reference to FIG. 6E, at the ultimate load 120, the conventional FRCM system (a) exhibited 2 to 3 cracks in the cementitious matrix, each about 1 mm wide. Cracks with a large width, such as over 0.3 mm, can reduce the durability of the FRCM system and lead to an increased deterioration of the system due to water penetration into the crack. In contrast, the UHPFRC-FRCM systems exhibited hundreds of microcracks (less than 100 μm). In some embodiments, the development of microcracks can result in the UHPFRC-FRCM surface being impermeable, thus increasing the overall durability of the UHPFRC-FRCM system.

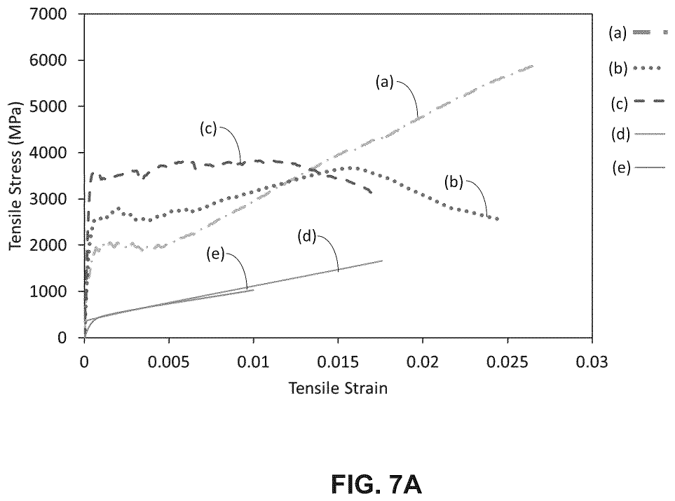

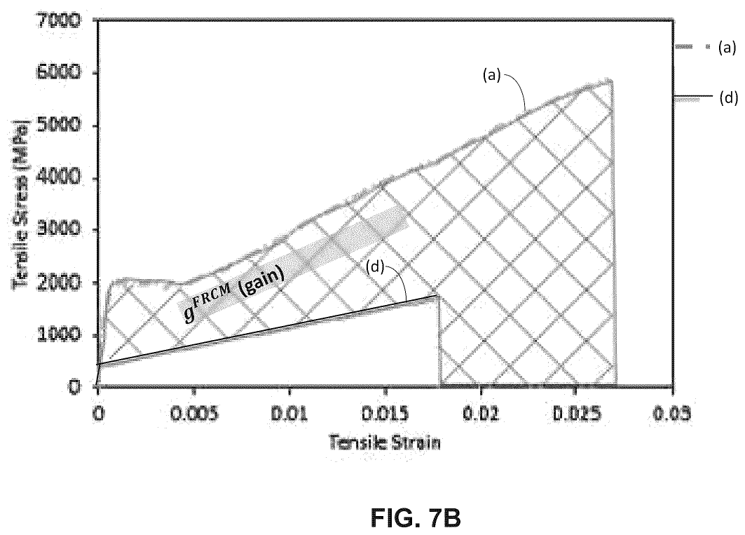

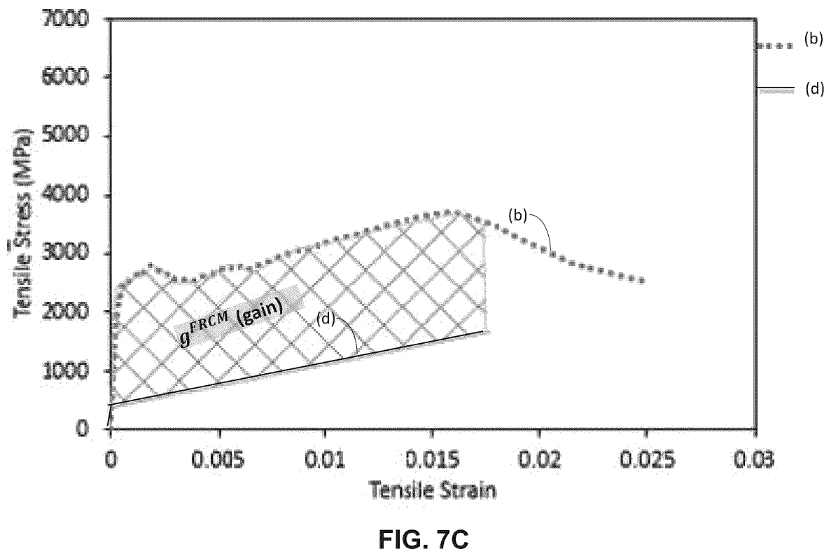

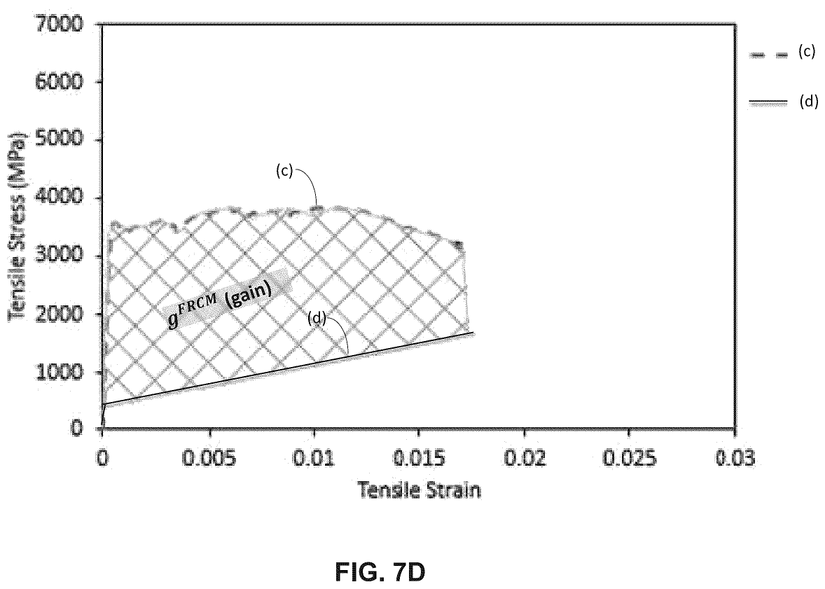

Referring now to FIG. 7A, the stress-strain curve of FRCM systems using the UHPRFC matrices in Table 2 (Examples 1 to 3) was compared with two conventional FRCM systems as reported in the ACI 549.4. Specifically, FIG. 7A shows a stress-strain curve for (a) an UHPFRC-FRCM system using a PBO mesh and an eco-UHPFRC matrix reinforced with UHMW-PE fibers (Example 3); (b) an UHPFRC-FRCM system using a PBO mesh and an eco-UHPFRC matrix reinforced with about 6 mm steel fibers (Example 2); (c) an UHPFRC-FRCM system using a PBO mesh and an UHPFRC matrix reinforced with about 6 mm steel fibers (Example 1); (d) a conventional FRCM system using a PBO mesh and a conventional cementitious matrix as reported in the ACI 549.4; and (e) a conventional FRCM system using a carbon mesh and a conventional cementitious matrix as reported in the ACI 549.4.

The tensile strength of the 5 systems ((a) to (e)) was calculated based on the following formula:

$$\frac{Tension load}{E q u i v alent fabric area} = \frac{P}{{A}_{f}}$$

As can be seen, the conventional PBO FRCM system (d) has an ultimate strength

$$( {σ}_{u}^{F R C M} )$$

of about 1664 MPa and the conventional carbon FRCM system (e) has an ultimate strength

$$( {σ}_{u}^{F R C M} )$$

of about 1031 MPa, as indicated in the ACI 549.4. In contrast, the UHPFRC-FRCM systems exhibited ultimate strengths of between 3 and 6 times these values. Specifically, the UHPFRC-FRCM system using the UHMW-PE-reinforced eco-UHPFRC matrix (a) exhibited the highest ultimate strength of about 6000 MPa, whereas the UHPFRC-FRCM systems using the about 6 mm steel-reinforced eco-UHPFRC matrix (b) and the steel-reinforced UHPFRC matrix (c) exhibited ultimate strengths of about 3800 MPa and about 3900 MPa, respectively. FIGS. 7B to 7D show the gain in the bulk fracture energy for the FRCM systems using the UHPFRC cementitious matrices (a), (b), (c) compared to the conventional PBO-FRCM system (d) that is reported in the ACI 549.4.

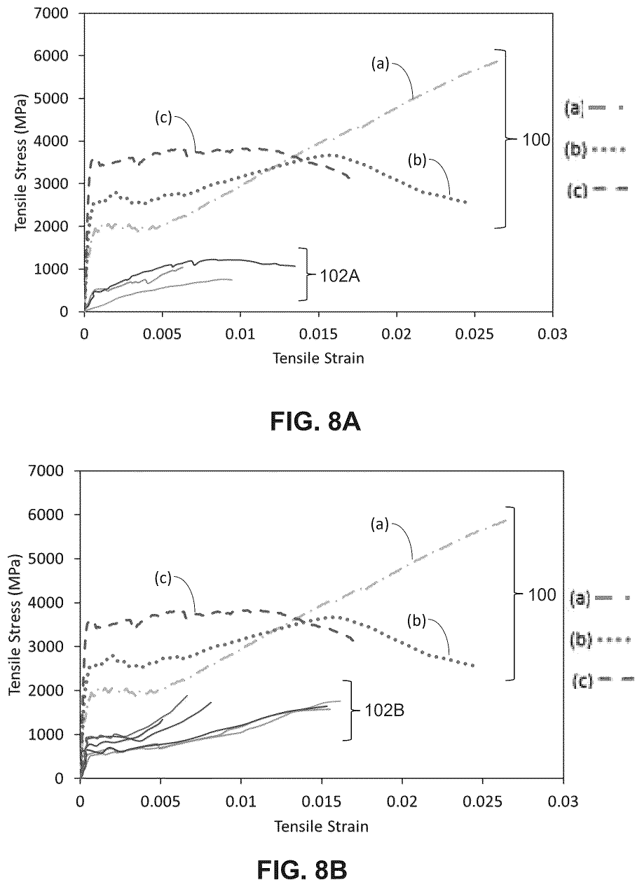

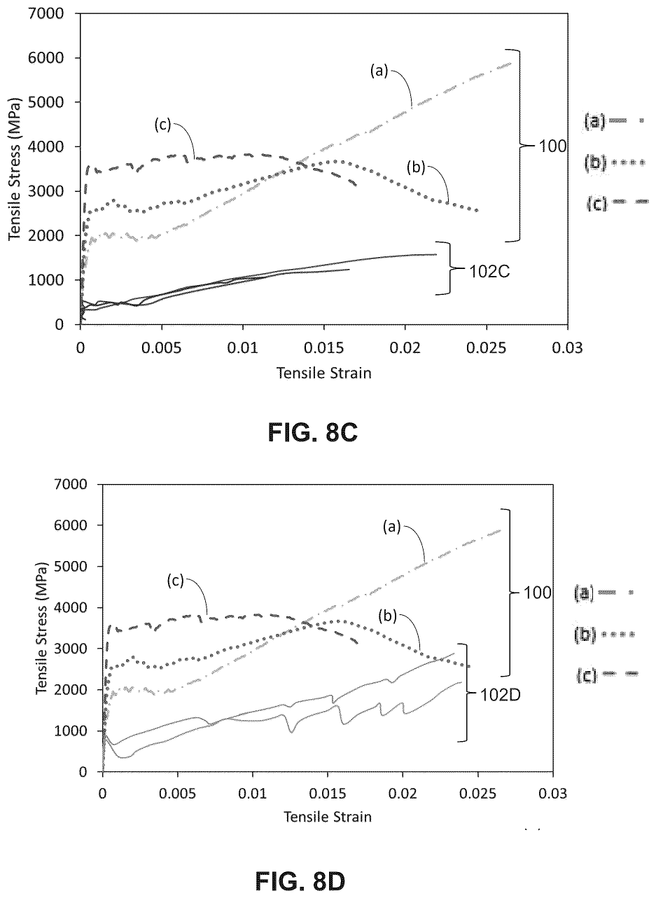

Referring now to FIGS. 8A to 8D, a comparative stress-strain analysis was conducted on each of the UHPFRC-FRCM systems 100 and the some of the FRCM systems as reported in the literature. Specifically, FIG. 8A shows a stress-strain analysis for FRCM systems as reported in Younis et al. (2017) 102A; FIG. 8B shows a stress-strain analysis for FRCM systems as reported in Pino and Nanni (2015) 102B; FIG. 8C shows a stress-strain analysis for FRCM systems as reported in Hadad et al. (2018) 102C; and FIG. 8D shows a stress-strain analysis for FRCM systems as reported in Ye et al. (2021) 102D. As can be seen, each of the UHPFRC-FRCM systems has a cracking stress and an ultimate strength that are significantly higher than the cracking stress and the ultimate strength of the FRCM systems reported in the literature. Indeed, in the cases of the conventional systems 102A, 102B, 102C shown in FIGS. 8A to 8C, the cracking stress of the UHPFRC-FRCM systems (i.e., the stress at which the first crack appears) is higher than the ultimate strength of either of the reported FRCM systems (i.e., the maximum stress the system can handle before failure). The conventional system shown in FIG. 8D has a much lower cracking stress and ultimate strength than the developed systems; however, the ultimate stress of the conventional systems shown in FIG. 8D is higher than the cracking stress of the developed systems, but significantly lower than the ultimate stress of each of the developed systems.

### Examples 4 to 15

Additional sample UHPFRC matrices were tested in FRCM systems that used a single or double layer FRCM with a PBO mesh and a single layer FRCM with a carbon mesh. Two types of cementitious matrices were used, as shown in Tables 3 and 4, to bond the PBO or carbon mesh or meshes to a concrete substrate. The cementitious matrices were either not reinforced (control Examples 4 and 12), were reinforced with 1% wt fibers (Examples 9 and 14), or were reinforced with 2% wt fibers (Examples 5 to 8, 10, 11, 13 and 15). The examples reinforced with 2% wt fibers included a single type of fiber or a mixed type of fibers. Examples 5 and 6 included 2% wt 6 mm steel fibers, Example 8 included 2% wt 13 mm steel fibers, and Examples 7 and 13 included 6 mm UHMW-PE fibers. Example 10 included 1% wt 6 mm steel fibers and 1% 6 mm UHMW-PE, whereas Examples 11 and 15 included 1% wt 13 mm steel fibers and 1% 6 mm UHMW-PE.

The PBO mesh had a tensile strength of between about 3300 and 5800 MPa and an ultimate strain of about 3% and the carbon mesh had a tensile strength of between about 1400 and 1700 MPa and an ultimate strain of about 3%. In the exemplary FRCM single-layer systems (Examples 8 to 15), the mesh was bonded to the concrete substrate with two layers of cementitious matrices. Specifically, the first layer of the cementitious matrices (i.e., the layer applied to the concrete substrate) were 5 mm thick and the second layer of the cementitious matrices (i.e., the layer applied to the mesh) were 5 mm thick. For the FRCM systems with 2 fabric layers (Examples 4 to 7), a third layer of the cementitious matrix was added. The size of the FRCM systems having a single mesh layer (Examples 8 to 15) was 400 mm×60 mm×10 mm and the size of the FRCM systems having two mesh layers (Examples 4 to 7) was 400 mm×60 mm×15 mm.

TABLE 3

| | CM-1 | CM-2 | CM-3 | CM-4 |
|---|---|---|---|---|
| Cement (kg/m³) | 900 | 400 | 400 | 400 |
| Mineral Filler | (8.54%) | (19.95%) | (19.95%) | (19.95%) |
| (% of total) | | | | |
| quartz micro-powder | 211 | — | — | — |
| (kg/m³) | | | | |
| granite powder (kg/m³) | — | 200 | 200 | 200 |
| Limestone (kg/m³) | — | 260 | 260 | 260 |
| SCM (kg/m³) | | | | |
| Silica Fume | 231 | 80 | 80 | 80 |
| Fly Ash | — | 200 | 200 | 200 |
| Sand (kg/m³) | | | | |
| Fine sand | 1020 | | | |
| Natural sand | | 590 | 590 | 590 |
| Silica Sand | | 400 | 400 | 400 |
| Water (kg/m³) | 109 | 176 | 213 | 194 |
| Total Cement, Filler, | 2471 | 2306 | 2343 | 2324 |
| SCM, Sand, + Water | | | | |
| (kg/m³) | | | | |
| Superplasticizer | 3.3 | 7.2 | 8.5 | 7.5 |
| (wt % of cement) | | | | |

TABLE 4

| | | | | Fiber | | Fabric | Numbers |
|---|---|---|---|---|---|---|---|
| FRCM Example | Cementitious | Reinforcing | | Length | | Mesh | of Mesh |
| System | Matrix | fibers (%) | Fiber Type | (mm) | | Type | Layers |
| PBO-FRCM-1L¹ | Premix bags | N/A | N/A | N/A | | PBO | 1 |
| (Conventional) | | | | | | | |
| PBO-FRCM-2L¹ | Premix bags | N/A | N/A | N/A | | PBO | 2 |
| (Conventional) | | | | | | | |
| 4 | CM-1 | 2% | Steel | 6 | mm | PBO | 2 |
| 5 | CM-2 | 2% | Steel | 6 | mm | PBO | 2 |
| 6 | CM-3 | 2% | UHMW-PE | 6 | mm | PBO | 2 |
| 7 | CM-2 | 2% | Steel | 13 | mm | PBO | 1 |
| 8 | CM-4 | 1% | UHMW-PE | 6 | mm | PBO | 1 |
| 9 | CM-4 | 2% | Steel (1%) | Steel - | | PBO | 1 |
| | | | and | 6 mm | | | |
| | | | UHMW-PE | UHMW- | | | |
| | | | (1%) | PE - 6 | | | |
| | | | | mm | | | |
| 10 | CM-4 | 2% | Steel (1%) | Steel - | | PBO | 1 |
| | | | and | 13 mm | | | |
| | | | UHMW-PE | UHMW- | | | |
| | | | (1%) | PE - 6 | | | |
| | | | | mm | | | |
| Carbon-FRCM-1L | Premix bags | N/A | N/A | N/A | | Carbon | 1 |
| (Conventional)² | | | | | | | |
| 11 | CM-3 | 2% | UHMW-PE | 6 | mm | Carbon | 1 |
| 12 | CM-4 | 1% | UHMW-PE | 6 | mm | Carbon | 1 |

| | | | | | | |
|---|---|---|---|---|---|---|
| 13 | CM-4 | 2% | Steel (1%) | Steel - | Carbon | 1 |
| | | | and | 13 mm | | |
| | | | UHMW-PE | UHMW- | | |
| | | | (1%) | PE - 6 | | |
| | | | | mm | | |

¹PBO-Mesh 105, RureGold, https://ruregold.com/download/pbo-mesh-105-data-sheet/?wpdmdl=2777&refresh=663215f4860441714558452; X Mesh Gold, Ruredil, https://rnc.com.my/wp-content/uploads/2022/12/6.-Ruredil-X-Mesh-Gold.pdf
²CSS-CM Cementitious Matrix, Simpson Strong-Tie, https://ssttoolbox.widen.net/view/pdf/jdglu0yjxm/T-R-CSSCM.pdf?t.download=true&u=cjmyin

### Experiments—Examples 4 to 13

TABLE 5

| | ~Crack | ~Ultimate | ~Ultimate |
|---|---|---|---|
| Example | Resistance | Strain | Stress (MPa) |
| PBO-FRMC-1L | 673 | 0.026 | 1620.366667 |
| PBO-FRMC-2L | 456 | 0.025 | 1565.556667 |
| 4 | 2145.657102 | 0.017483333 | 3043.5 |
| 5 | 1591.7219917 | 0.015876667 | 2469 |
| 6 | 1458.019568 | 0.031366667 | 4629.26 |
| 7 | 2732.12558 | 0.011466667 | 3762.916667 |
| 8 | 1697.596568 | 0.029533333 | 3816.353333 |
| 9 | 1936.265423 | 0.026966667 | 4022.683333 |
| 10 | 1898.473309 | 0.032573333 | 4581.16 |
| Carbon-FRMC-1L | 145.8808333 | 0.020045803 | 1020.980192 |
| 11 | 423.1458718 | 0.015313 | 1628.993 |
| 12 | 516.6821538 | 0.021697 | 1348.798 |
| 13 | 538.4930256 | 0.025 | 1503.613 |

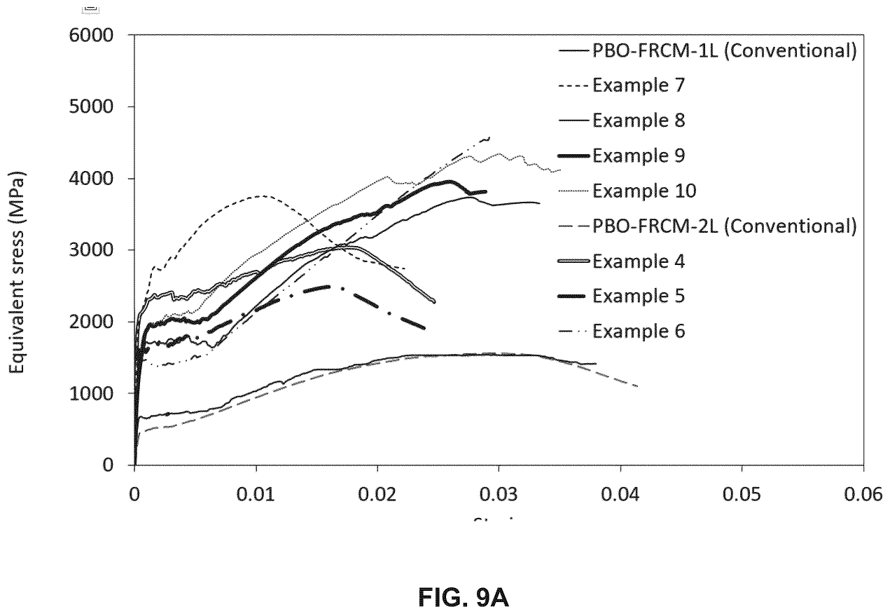

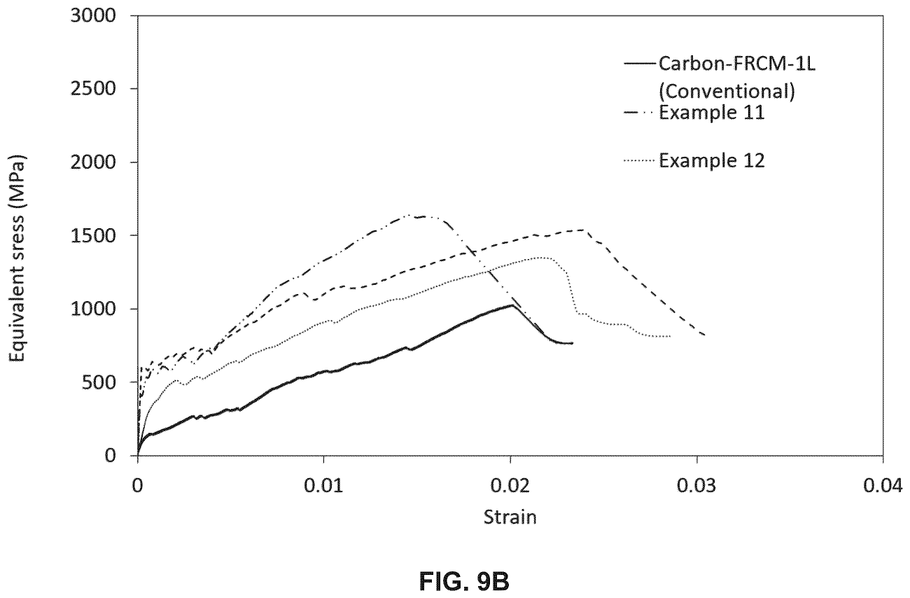

Referring now to FIG. 9A, the stress-strain (which can also be referred to as the equivalent stress—tensile strain) curve of FRCM systems using the cementitious matrices in Table 3 reinforced with the fibers and PBO fabric meshes shown in Table 4 (Examples 5 to 10) were compared with a conventional FRCM system using a pre-mixed conventional cementitious matrix and one layer of a PBO mesh (PBO-FRCM-1L (Conventional) or two layers of PBO meshes (PBO-FRCM-2L (Conventional)). The ultimate strength

$$( {σ}_{u}^{F R C M} )$$

of each example and the conventional control FRCM systems are shown in Table 5. Specifically, FIG. 9A shows a stress-strain curve for FRCM systems using two PBO fabric meshes bonded with an UHPFRC matrix reinforced with 2% 6 mm steel fibers (Example 4) or an eco-UHPFRC matrix reinforced with 2% 6 mm steel fibers (Example 5) or 2% 6 mm UHMW-PE fibers (Example 6) and FRCM systems using a single PBO fabric mesh bonded with an eco-UHPFRC matrix reinforced with 2% 13 mm steel fibers (Example 7), 1% of 6 mm UHMW-PE fibers (Example 8), or 50/50 UHMW-PE fibers and 6 mm (Example 9) or 13 mm (Example 10) steel fibers.

As can be seen in Table 5 and FIG. 9A, the FRCM system using a single PBO mesh layer bonded with a conventional cementitious matrix (PBO-FRCM-1L (Conventional)) had an ultimate strength

$$( {σ}_{u}^{F R C M} )$$

of about 1620 MPa and the FRCM system using a double PBO mesh layer bonded with a conventional cementitious matrix (PBO-FRCM-2L (Conventional)) had an ultimate strength

$$( {σ}_{u}^{F R C M} )$$

of about 1566 MPa. In contrast, the exemplary UHPFRC-FRCM systems (Examples 4 to 10) exhibited ultimate strengths of between about 1.5 and 3 times these values. Specifically, the UHPFRC-FRCM system using the UHMW-PE-reinforced (Example 6) or mixed 13 mm steel and UHMW-PE-reinforced (Example 10) eco-UHPFRC matrices exhibited the highest ultimate strength of about 4629.26 MPa and about 4581.16 MPa, respectively.

Specifically, the equivalent stress-strain behavior of the UHPFRC-FRCM systems is graphically represented in FIG. 9A, which depicts the average curves obtained from three tensile tests for each system. Notably, the conventional PBO-FRCM-2L and PBO-FRCM-1L systems exhibit a significantly lower cracking stress of about 456 MPa and about 673 MPa, respectively, due to the inferior tensile properties of the conventional cementitious matrix.

Beyond the cracking stress point, a significant decrease in stiffness was observed for the PBO-FRCM-2L and PBO-FRCM-1L systems as slippage occurs between the cementitious matrix and the PBO mesh or meshes, therefore reaching an ultimate stress of about 1566 MPa and about 1620 MPa, respectively. These values are equivalent to about 28% to 47% and of the PBO mesh's capacity (between about 3300 and 5800 MPa). In contrast, the exemplary UHPFRC-FRCM with one or two PBO fabric meshes exhibit an increase of ultimate strength of up to about 283% and 295%, respectively, and an increase of crack resistance of up to about 246% and 377%, respectively, when compared with the reference system (Conventional PBO-FRCM) with same mesh configuration (1L or 2L). As such, the exemplary UHPFRC-FRCM systems show improved durability for use with retrofitted structures. It was observed that the enhancement in cracking stress is attributed to the higher tensile strength of the exemplary UHPFRC cementitious matrix, while the enhancement in the ultimate stress is attributed to the strong bond between the mesh and the exemplary UHPFRC cementitious matrix.

The behavior of the exemplary UHPFRC-FRCM systems vary depending on the type and quantity of fiber content used in the exemplary UHPFRC cementitious matrix. For example, Examples 4, 5, and 7, which are the exemplary UHPFRC-FRCM systems that use steel fibers, achieved about 93%, about 75%, and about 114%, respectively, of the ultimate strength capacity of the PBO mesh (the PBO fabric mesh used has a tensile strength in the range of about 3300 to 5800 MPa depending on the method of characterization of the fabric; the lower limit was assumed as tested by other researchers from the literature, for example, see D'Antino, T., Carloni, C., Sneed, L. H., & Pellegrino, C. (2014). Matrix-fiber bond behavior in PBO FRCM composites: A fracture mechanics approach. Engineering Fracture Mechanics, 117, 94-111). Partial utilization of the ultimate strength capacity of the fabric mesh can be attributed to the occurrence of partial slippage between the exemplary UHPFRC cementitious matrices and the PBO mesh. The exemplary UHPFRC-FRCM systems that incorporated 2% UHMW-PE fibers (Example 6), 1% UHMW-PE fibers (Example 8) or a hybrid mixture of fibers (Examples 9 and 10) exhibited a rupture of the PBO mesh within the cementitious matrix at significantly higher stress levels than the rupturing capacity of the PBO mesh alone (the ultimate strength). Specifically, up to about 140% of the PBO mesh ultimate strength. The exhibited increase in ultimate stress to the rupture point is a result of the contribution of the exemplary UHPFRC cementitious matrix.

Referring now to FIG. 9B, the stress-strain (which can also be referred to as the equivalent stress—tensile strain) curve of FRCM systems using the cementitious matrices in Table 3 reinforced with the fibers and a single carbon fabric mesh shown in Table 4 (Examples 11 to 13) were compared with a conventional FRCM system using a single carbon mesh layer (Carbon-FRCM-1 L). Specifically, FIG. 9B shows a stress-strain curve for FRCM systems using a single carbon fabric mesh bonded with an eco-UHPFRC matrix reinforced 1% or 2% 6 mm UHMW-PE fibers (Examples 11 and 12, respectively) or 50/50 UHMW-PE fibers and 13 mm steel fibers (Example 13).

As can be seen in Table 5 and FIG. 9B, the FRCM system using a single carbon mesh layer bonded with a conventional cementitious matrix (Carbon-FRCM-1 L) had an ultimate strength

$$( {σ}_{u}^{F R C M} )$$

of about 1020.98 MPa. In contrast, the exemplary UHPFRC-FRCM systems (Examples 11 to 13) exhibited ultimate strengths of between about 1.3 and 1.6 times these values.

With reference to both FIGS. 9A and 9B, as can be seen, each of the exemplary UHPFRC-PRCM systems (Examples 4 to 10 and 11 to 13) have a cracking stress

$$( {σ}_{c r}^{F R C M} )$$

and an ultimate strength

$$( {σ}_{u}^{F R C M} )$$

that is significantly higher than the control FRCM systems that used a cementitious matrix that was not fiber-reinforced.

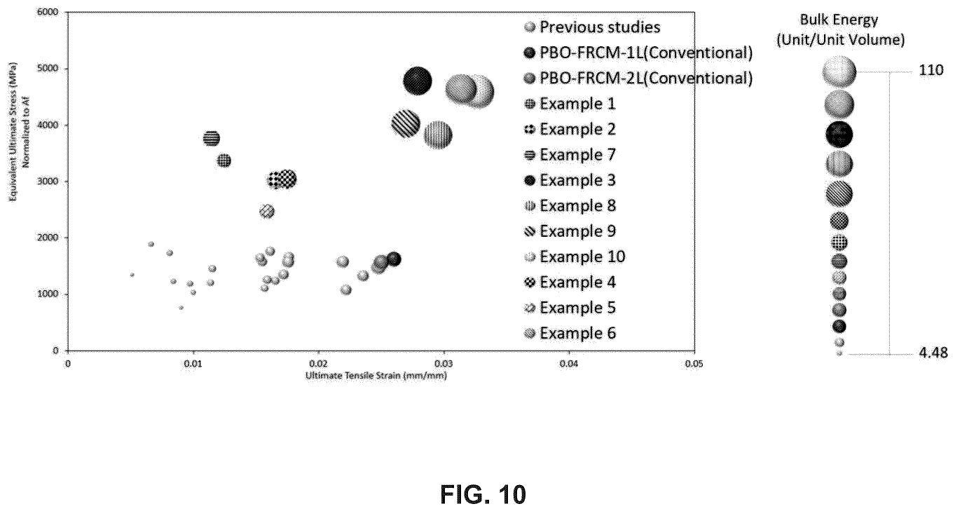

Referring now to FIG. 10, a comparative bubble chart showing the equivalent ultimate stress (MPa),

$${σ}_{u}^{F R C M} ,$$

the ultimate strain (mm/mm, %)

$${ε}_{u}^{F R C M} ,$$

and the tensile bulk fracture energy (energy/unit volume), g^{FRCM}, for UHPFRC-FRCM systems using the UHPFRC matrices in Tables 2 to 4 and conventional FRCM systems from the literature (as shown in Table 6). As can be seen, each of the UHPFRC-FRCM systems surprisingly exhibited an ultimate strength (ultimate stress) that is higher than the lower limit of ultimate stress for the PBO mesh by itself (which can also be referred to as the lower limit for rupturing the PBO mesh). The UHPFRC-FRCM system that used the 2% UHMW-PE reinforced eco-UHPFRC (example 3 or example 6) exhibited the highest ultimate strength (about 4630 to 4778 MPa), and the UHPFRC-FRCM system that used a hybrid of UHMW-PE and steel fibers (Example 10) exhibited the highest tensile bulk fracture energy (110 energy/unit volume).

TABLE 6

| | Ultimate | Equivalent | |
|---|---|---|---|
| | tensile strain | ultimate stress | |
| | (mm/mm) | (MPa) | Energy |
| Example 1 | 0.012433333 | 3363.333333 | 29.59525483 |
| Example 2 | 0.016566667 | 3021 | 38.81401614 |
| Example 7 | 0.011466667 | 3762.916667 | 36.89333333 |
| Example 3 | 0.0279 | 4777.35 | 80.63333333 |
| Example 8 | 0.029533333 | 3816.353333 | 79.93333333 |
| Example 9 | 0.026966667 | 4022.683333 | 78.66666667 |
| Example 10 | 0.032573333 | 4581.16 | 110.26 |
| Example 4 | 0.017483333 | 3043.5 | 45.65 |
| Example 5 | 0.015876667 | 2469 | 31.76333333 |
| Example 6 | 0.031366667 | 4629.26 | 91.37666667 |
| PBO-FRCM-1L | 0.026 | 1620.366667 | 30.34069707 |
| (Conventional) | | | |
| PBO-FRCM-2L | 0.025 | 1565.556667 | 31.75 |
| (Conventional) | | | |
| Previous | 0.01615 | 1763.29738 | 16.27367014 |
| Studies | 0.01552 | 1573.59606 | 15.78131095 |
| | 0.01532 | 1643.06383 | 16.02524853 |
| | 0.00511 | 1339.54066 | 4.489673022 |
| | 0.00812 | 1732.05723 | 8.638791192 |
| | 0.00664 | 1887.81777 | 7.574572863 |
| | 0.0176 | 1664 | 17.800096 |
| | 0.01 | 1031 | 6.9295 |
| | 0.02354 | 1326.10837 | 20.59038423 |
| | 0.01569 | 1101.47783 | 11.42123152 |
| | 0.01654 | 1239.40887 | 13.73097539 |
| | 0.0172 | 1349.75369 | 17.86008869 |
| | 0.02191 | 1574.38424 | 23.21414779 |
| | 0.02218 | 1077.79141 | 19.11467975 |
| | 0.01589 | 1256.44172 | 13.39918529 |
| | 0.01139 | 1199.5092 | 10.00704786 |
| | 0.01151 | 1452.76074 | 12.08415214 |
| | 0.01757 | 1572.51534 | 22.06172269 |
| | 0.00902 | 759.76845 | 4.621225752 |
| | 0.00974 | 1185.23878 | 8.133868307 |
| | 0.00841 | 1223.73372 | 7.372063673 |
| | 0.02479 | 1474.35897 | 29.20508549 |

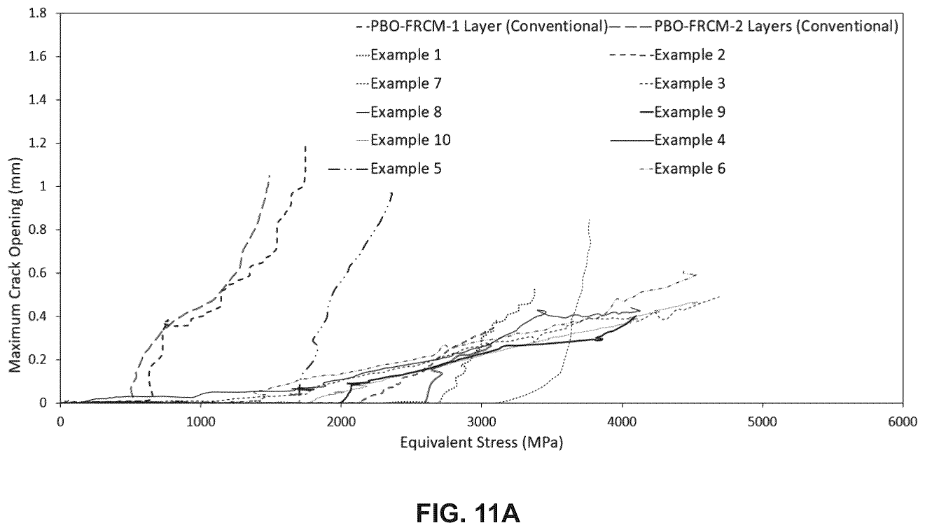

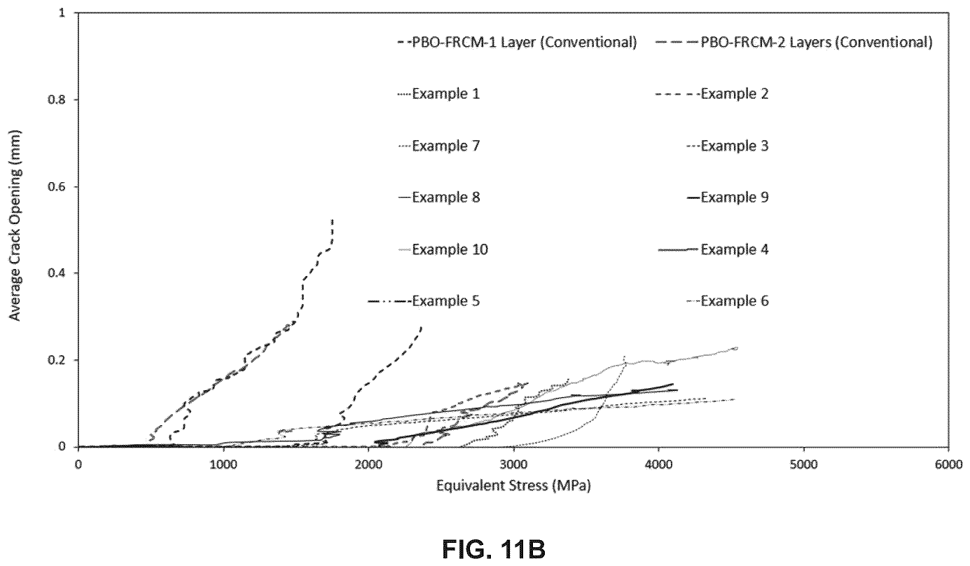

Referring now to FIGS. 11A and 11B, a comparative chart showing the maximum and average crack width, respectively, against stress for the conventional PBO-FRCM-1L, conventional PBO-FRCM-2L, and Examples 1 to 10 UHPFRC-FRCM systems with PBO fabric mesh or meshes using the UHPFRC matrices described in Tables 3 and 4. As can be seen, the maximum crack opening widths observed in the UHPFRC-FRCM systems are significantly smaller than the FRCM systems that are not reinforced with fibers. Specifically, at lower levels of stress (MPa), where the serviceability limit state is important, the crack widths of the conventional FRCM system is approximately 5 to 20 times larger than those of the UHPFRC-FRCM systems.

Several alternative embodiments and examples have been described and illustrated herein. The embodiments of the invention described above are intended to be exemplary only. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. It is understood that the invention may be embodied in other specific forms without departing from the central characteristics thereof. The present examples and embodiments, therefore, are to be considered in all respects as illustrative and not restrictive, and the invention is not to be limited to the details given herein. Accordingly, while the specific embodiments have been illustrated and described, numerous modifications come to mind. The scope of the invention is therefore intended to be limited solely by the scope of the appended claims.

1. A fabric-reinforced cementitious matrix (FRCM) system for a concrete substrate, the FRCM system comprising a high tensile strength cementitious matrix and a fabric mesh, wherein an ultimate strength of the high tensile strength cementitious matrix is at least 1/600^{th} of an ultimate strength of the fabric mesh or at least 2.5 MPa.

2. The FRCM system of claim 1, wherein the ultimate strength of the high tensile strength cementitious matrix is at least 5 MPa or at least 7 MPa.

3. The FRCM system of claim 2, wherein the high tensile strength cementitious matrix has a compression strength of at least 70 MPa.

4. A fabric-reinforced cementitious matrix (FRCM) system for a concrete substrate, the FRCM system comprising a high tensile strength cementitious matrix and a fabric mesh, wherein the high tensile strength cementitious matrix has a compression strength of at least 70 MPa.

5. The FRCM system of claim 4, wherein the compression strength of the high tensile strength cementitious matrix is at least 100 MPa and/or the high tensile strength cementitious matrix has an ultimate strength of at least 2.5 MPa.

6. (canceled)

7. The FRCM system of claim 1, wherein an ultimate strength of the FRCM system is at least 50% of an ultimate strength of the fabric mesh.

8. The FRCM system of claim 4, wherein an ultimate strength of the FRCM system is at least 50% of the ultimate strength of the fabric mesh.

9. (canceled)

10. The FRCM system of claim 7, wherein the ultimate strength of the FRCM system is equal to or greater than the ultimate strength of the fabric mesh.

11. The FRCM system of claim 1, wherein the high tensile strength cementitious matrix comprises
about 100 kg/m³ to about 300 kg/m³ water;
about 400 kg/m³ to about 1200 kg/m³ cement;
about 600 kg/m³ to about 1500 kg/m³ sand; and
at least about 1% wt superplasticizer.

12. The FRCM system of claim 1, wherein the high tensile strength cementitious matrix comprises between about 0.3% wt and about 8% wt fibers and the fibers comprise at least one of: steel fibers, polyparaphenylene benzobisoxazole (PBO) fibers, carbon fibers, glass fibers, basalt fibers, and synthetic polymer fibers with a length-to-diameter ratio greater than 10.

13-17. (canceled)

18. The FRCM system of claim 12, wherein the high tensile strength cementitious matrix further comprises polyvinyl alcohol (PVA) fibers as a secondary fiber that is configured to provide fire resistance to the FRCM system.

19. The FRCM system of claim 12, wherein the fibers comprise micro-steel fibers.

20. The FRCM system of claim 12, wherein a tensile bulk fracture energy of the high tensile strength cementitious matrix is greater than 1/7000^{th} of a tensile bulk fracture energy of the fabric mesh and/or a tensile bulk fracture energy of the high tensile strength cementitious matrix has a strain
$$( {ε}_{u}^{Cem . Matrix} )$$
at ultimate stress that is greater than 0.1%.

21-22. (canceled)

23. The FRCM system of claim 11, wherein the fibers comprise ultra-high-molecular-weight polyethylene (UHMW-PE) fibers and/or a steel mesh.

24-28. (canceled)

29. The FRCM system of claim 1, wherein the high tensile strength cementitious matrix further comprises about 100 kg/m³ to about 400 kg/m³ supplementary cementitious material (SCM) and the SCM comprises silica fume, fly ash, slag cement, coal, or a combination thereof.

30. (canceled)

31. The FRCM system of claim 1, wherein the high tensile strength cementitious matrix further comprises about 10 kg/m³ to about 600 kg/m³ mineral filler and the mineral filler comprises quartz powder, quartz micro-powder, granite powder, marble powder, limestone powder, or combinations thereof with a diameter of less than 150 μm.

32-35. (canceled)

36. A method of reinforcing a damaged area of a concrete substrate, the method comprising:
applying a first layer of a high tensile strength cementitious matrix on the damaged area;
embedding a fabric mesh into the first layer of the high tensile strength cementitious matrix; and
applying a second layer of the high tensile strength cementitious matrix on the fabric mesh;
wherein at least one of:
the high tensile strength cementitious matrix has an ultimate strength of at least 2.5 MPa; and
the high tensile strength cementitious matrix has a compression strength of at least 70 MPa.

37. (canceled)

38. The method of claim 36, wherein the high tensile strength cementitious matrix comprises between about 0.5% wt and about 8% wt fibers.

39. (canceled)

40. The method of claim 38, wherein the fibers have a tensile strength of between about 1500 MPa and about 6000 MPa, a diameter of between about 0.001 mm and about 1 mm, and a length of between about 1 mm and about 40 mm.

41-43. (canceled)

44. The method of claim 38, wherein the high tensile strength cementitious matrix further comprises polyvinyl alcohol (PVA) fibers as a secondary fiber that is configured to provide fire resistance to the FRCM system.

45-81. (canceled)
